(19) United States
(12) Patent Application Publication
(10) Pub. No.: US 2004/0249759 A1
(43) Pub. Date: Dec. 9, 2004

(54) Content using apparatus

(76) Inventors: Akio Higashi, Takatsuki-shi (JP); Katsumi Tokuda, Ikeda-shi (JP); Motoji Ohmori, Hirakata-shi (JP); Mitsuhiro Inoue, Osaka-shi (JP); Toshihisa Abe, Izumisano-shi (JP); Masanori Nakanishi, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/492,685

(22) PCT Filed: Sep. 30, 2003
(86) PCT No.: PCT/JP03/12466

(30) Foreign Application Priority Data
Sep. 30, 2002 (JP) 2002-286746

(51) Int. Cl. G06F 17/60

(52) U.S. Cl. 705/59

(57) ABSTRACT

A content using apparatus (103) for providing content use to a user under a license that grants the content use includes: a content using unit (202) for providing the content use to the user; a content use control unit (212) for controlling the content use on the content using unit (202) under the license; a value information storage unit (213) for obtaining and storing a value information tag block (504) indicating a discount amount (605) indicating a benefit for the user, a value information giving condition (603) for allowing the user to use the discount by the discount amount (605) depending on the content use and a discount ticket applicable condition (604); and a value information using unit (214) for judging whether the value information giving condition (603) and the discount ticket applicable condition (604) are satisfied or not and allowing the user to use the discount amount (605) if the conditions are satisfied.

### TECHNICAL FIELD

The present invention relates to apparatuses for using digital contents such as audios and videos distributed via communication and broadcasting, and particularly to content using apparatuses for controlling content use, handling billing and giving users value information depending on the users' content use.

### BACKGROUND ART

In recent years, systems for distributing digital contents such as music, videos and games for use or a user's terminal via the Internet, digital broadcasting or the like have been in a phase of practical use.

A conventional content using apparatus receives contents with additional data including benefit information for users, and gives them the benefit information on their use of the data added to the contents (See Japanese Laid-Open Patent Application No. 2002-112012, for example).

For example, copyright information of a content is given as data added to the content, and benefit information is given to a user when the user uses the copyright information. Or, advertising information is given as data added to a content, and benefit information is given to a user when the user views the advertising information.

As mentioned above, in the conventional content using apparatus, benefit information is given to users when they use additional data.

By the way, in a common content distribution system, DRM (Digital Rights Management) is used for protecting copyright holders' rights and preventing unauthorized use of contents by malicious users or the like. DRM is a technology for enabling secure control of users' content use such as reproduction and copying of contents using a security technology such as an encryption technology.

On the other hand, it can be said that digital information with added value such as discounts and free tickets of contents (hereinafter referred to as value information) is also information which should be given to the users in a secure manner and managed just like copyright protection of the contents because only the users who obtain the value information can use the value information for discount services or exchange it with premium contents.

Therefore, it is considered that a broader variety of services can be realized if, as a result of a secure grasp of content use by DRM, value information can be given to users depending on their content use and thus the users can use the value information in a variety of forms.

Value information is given depending on various forms of content use. For example, value information is given to a user only when he uses all of a plurality of specific contents (such as a series of contents), or value information is given to a user if he uses a content during a certain time of a day (a time of a day other than busy time, for example) in a case of streaming distribution.

Also, it is considered that services that are more flexible and convenient for users can be realized if they can exchange their obtained value information with their friends or present it to them as a gift.

However, since the conventional content using apparatus gives value information only when additional data accompanied to contents is used, It cannot give value information flexibly depending on content use.

### DISCLOSURE OF INVENTION

The present invention is to solve the above existing problem, and aims at realizing a content using apparatus that allows giving of value information depending on content use under control over content use and use of the obtained value information for billing. Also, the present invention aims at providing a content using apparatus that allows exchange of value information with other content using apparatuses.

In order to achieve the above objects, the content using apparatus according to the present invention is a content using apparatus for providing content use to a user under a license that grants the content use, comprising: a value information storage unit operable to obtain and store value information indicating a benefit for the user; a condition judgment unit operable to judge, depending on the content use, whether a condition for allowing the user to use the value information is satisfied or not; and a value information using unit operable to allow the user to use the value information when the condition is satisfied as a result of the judgment.

The content using apparatus according to the present invention further comprises: a communication unit operable to access another content using apparatus, and give and receive the value information to and from said another content using apparatus; and a giving and receiving limitation unit operable to limit the giving and receiving of the value information, wherein the communication unit gives and receives the value information to and from said another content using apparatus under the limitation.

The content using apparatus according to the present Invention gives value information depending on content use so as to use the value information in a variety of manners, so flexible services can be realized. Also, since the value information can be exchanged between users, a system that offers the users higher convenience can be configured.

The present invention can be realized not only as the above-mentioned content distribution system or a content using apparatus, but as a content distribution method or a content using method including steps executed by characteristic units included in this content distribution system or content using apparatus, or as a program for causing a computer to execute these steps. Needless to say, such a program can be distributed via a recording medium such as a CD-ROM or a transmission medium such as the Internet.

As further information about technical background to this application, Japanese Patent Application No. 2002-286746 filed on Sep. 30, 2002, is incorporated herein by reference.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings

FIG. 1 is a general view of a rough structure of a content distribution system 1 according to a first embodiment of the present invention.

FIG. 2 is a functional block diagram showing a structure of a content using apparatus 103 according to the first embodiment of the present invention.

FIG. 3 is a diagram showing a rough structure of a data carousel 300 according to the first embodiment of the present invention.

FIG. 4 is a diagram showing a structure of ACI 304 according to the first embodiment of the present invention.

FIG. 5 is a diagram showing a structure of a license ticket 404 according to the first embodiment of the present invention.

FIG. 6 is a diagram showing a value information tag block 504 of a discount ticket according to the first embodiment of the present invention.

FIG. 7 is a diagram showing a structure of a value information tag block 504 of electronic value according to the first embodiment of the present invention.

FIG. 8 is a diagram showing a structure of a value information table 800 in a value information storage unit 213 according to the first embodiment of the present invention.

FIG. 9 is a diagram showing a rough structure of a database in a content use management unit 215 according to the first embodiment of the present invention.

FIG. 10 is a flowchart showing content storage processing in a content using apparatus 103 according to the first embodiment of the present invention.

FIG. 11 is a flowchart showing content purchase processing and content using processing in the content using apparatus 103 according to the first embodiment of the present invention.

FIG. 12 is a flowchart showing value information using processing in the content using apparatus 103 according to the first embodiment of the present invention.

FIG. 13 is a functional block diagram showing a structure of a content using apparatus 103 according to a second embodiment of the present invention.

FIG. 14 is a flowchart showing content purchase processing and content using processing in the content using apparatus 103 according to the second embodiment of the present invention.

FIG. 15 is a diagram showing a structure of a value information tag block 504 of point information in a case where value information is given in a time of a day other than a busy time according to the second embodiment of the present invention.

FIG. 16 is a flowchart showing value information giving processing in the content using apparatus 103 according to the second embodiment of the present invention.

FIG. 17 is a diagram showing a structure of a value information tag block 504 of point information in a case where value information is given to heavy users according to the second embodiment of the present invention.

FIG. 18 is a diagram showing a structure of a LT usage history table 1800 according to the second embodiment of the present invention.

FIG. 19 is a flowchart showing processing of exchanging point information with electronic value in the content using apparatus 103 according to the second embodiment of the present invention.

FIG. 20 is a functional block diagram showing a structure of a content using apparatus 103 according to a third embodiment of the present invention.

FIG. 21 is a flowchart showing content purchase processing and content using processing in the content using apparatus 103 according to the third embodiment of the present invention.

FIG. 22 is a diagram showing a structure of billing information 2200 according to the third embodiment of the present invention.

FIG. 23 is a flowchart showing value information giving processing on content use in the content using apparatus 103 according to the third embodiment of the present invention.

FIG. 24 is a diagram showing a structure of value information 2400 according to the third embodiment of the present invention.

FIG. 25 is a flowchart showing value information giving processing depending on LT obtainment situations in the content using apparatus 103 according to the third embodiment of the present invention.

FIG. 26 is a diagram showing a rough structure of a data carousel 2600 according to a fourth embodiment of the present invention.

FIG. 27 is a functional block diagram showing a structure of a content using apparatus 103 according to the fourth embodiment of the present invention.

FIG. 28 is a flowchart showing content using processing in the content using apparatus 103 according to the fourth embodiment of the present invention.

FIG. 29 is a diagram showing a structure of a value information tag block 2900 according to the fourth embodiment of the present invention.

FIG. 30 is a general view of a rough structure of a content distribution system 5 according to a fifth embodiment of the present invention.

FIG. 31 is a functional block diagram showing a structure of a content using apparatus 103 according to the fifth embodiment of the present invention.

FIG. 32 is a flowchart showing value information giving and receiving processing in a first content using apparatus 103 and a second content using apparatus 103 according to the fifth embodiment of the present invention.

FIG. 33 is a diagram showing a structure of an access information management table 3300 held in each content using apparatus 103 according to the fifth embodiment of the present invention.

FIG. 34 is a flowchart showing value information giving and receiving processing in the first content using apparatus 103, the second content using apparatus 103 and a home server 3002 according to the fifth embodiment of the present invention.

FIG. 35 is a diagram showing a structure of an access information management table 3500 held in the home server 3002 according to the fifth embodiment of the present invention.

### BEST MODE FOR CARRYING OUT THE INVENTION

(First Embodiment)

The first embodiment of the present invention will be explained in detail with reference to the drawings.

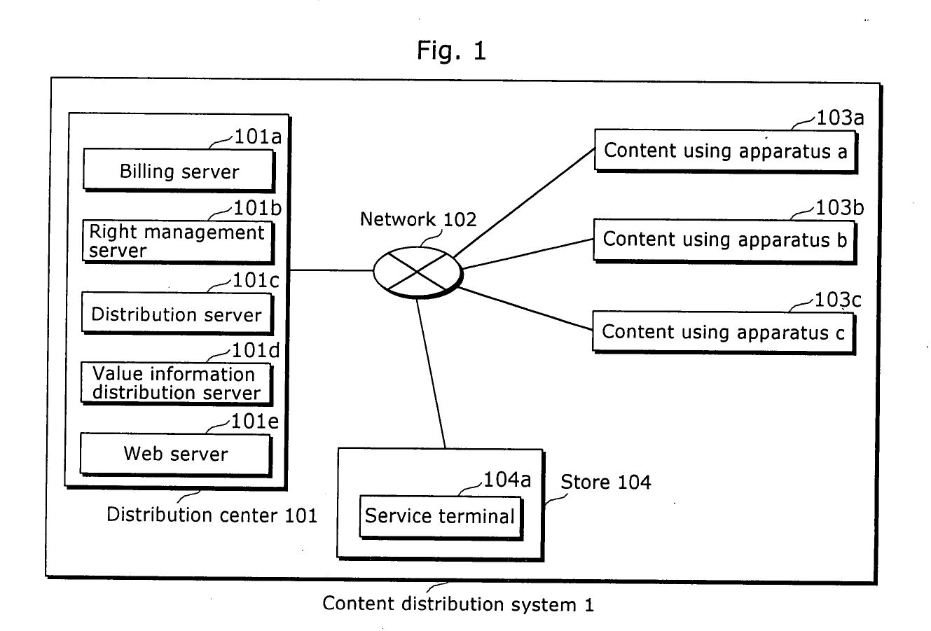

FIG. 1 is a general view of a rough structure of a content distribution system 1 according to the first embodiment of the present invention.

This content distribution system is a system for using, on a content using apparatus, digital contents distributed from a distribution center via a network, a portable medium or the like, and includes a distribution center 101 for distributing contents or the like, content using apparatuses 103a˜103c for using contents and a network 102 for connecting these. A store 104 for selling contents and electronic value is also connected to the network 102.

Here, the electronic value means electronic value information supported by the values in actual currencies, and can by itself function as an alternative to cash.

The distribution center 101 includes a billing server 101a for handling billing, a right management server 101b for managing and distributing usage rights (licenses) of contents, a distribution server 101c for distributing contents, a value information distribution server 101d for distributing value information, and a Web server 101e for providing a Web screen.

The billing server 101a is a server apparatus for purchasing licenses for contents via the Internet and the like, or handling online billing when purchasing electronic value. To be more specific, the billing server 101a makes billing and settlement using credit cards, or manages users' bank account numbers registered in the billing server 101a in advance so as to make billing and settlement based on purchase histories and the like uploaded from the content using apparatuses 103a˜103c via the network 102. It also distribute billed amounts (fees for uses of contents and licenses) together with the contents and licenses when the content using apparatuses 103a˜103c make billing and settlement.

The right management server 101b is a server apparatus for managing usage rights of contents owned by users and giving licenses for the contents to the users. To be more specific, in the network distribution system, the right management server 101b manages the licenses for the contents owned by each user or on each of the content using apparatuses 103a˜103c to distribute the licenses to the content using apparatuses 103a˜103c via the network 102 based on the users' requests. Or, in a push-type distribution system such as digital broadcasting, it can be configured so that the right management server 101b distributes temporarily invalidated licenses together with contents and the content using apparatuses 103a˜103c perform billing processing to validate the licenses for enabling the users to use the contents. Note that a license is comprised of a decryption key (a content key) for decrypting an encrypted content, usage rules such as the expiration date and the permitted number of uses of the content, and the like. Further, as an encryption algorithm for encrypting contents, a common key encryption algorithm such as AES (Advanced Encryption Standard) and Triple DES (Data Encryption Standard) are generally used.

The distribution server 101c is a server apparatus for distributing contents to the content using apparatuses 103a˜103c or the store 104 via the network 102. To be more specific, the distribution server 101c distributes MPEG contents which are digitally compressed by a compression method such as MPEG-2 (Moving Picture Expert Group Phase 2) and MPEG-4 (Moving Picture Expert Group Phase 4) and then encrypted by AES or the like if necessary.

For example, in a case of the Internet, the distribution server 101c may be a server apparatus for streaming contents using a protocol such as RTP (Realtime Transfer Protocol) and UDP (User Datagram Protocol), or a server apparatus for providing download contents using a protocol such as FTP (File Transfer Protocol) and HTTP (Hyper Text Transfer Protocol). Also, in a case of digital broadcasting, it may be a delivery apparatus for providing stream contents according to MPEG-2 TS (Transport Stream), or a delivery apparatus for providing storage contents based on a data carousel transmission system as defined in ARIB (Association of Radio Industries and Businesses) STD-B24.

The value information distribution server 101d is a server apparatus for distributing value information, together with contents and licenses or separately from them, to the content using apparatuses 103a˜103c.

Here, value information is a variety of electronic information which is useful for some purpose. Particularly it is a variety of electronic information convertible into other value information, for example, billing-related information such as above-mentioned electronic value and a discount coupon which can be used for discount purchase; point information which is a certain number of points accumulated to exchange with a license, a content or the like; and information that is valuable in itself and has no direct relation to billing such as a premium content, a concert ticket, an admission ticket, an accommodation coupon and the like.

For example, the value information distribution server 101d generates value information such as electronic value, a discount coupon and a premium content, and distributes it to a user in the following manner: it sends the value information to the distribution server 101c and embeds it into the content as an electronic watermark for distribution to the user; it sends the value information to the right management server 101b for distribution together with a license to the user; or it judges whether to give the value information to the user or not for distribution, when the user has direct access on the content using apparatus 103a, 103b or 103c. Note that value information may be binary information, information described in a script language such as XML (Extensible Markup Language), or electronic watermark information.

The Web server 101e provides a screen, such as a content purchase screen and an electronic value purchase screen, for users to access various services on the content using apparatuses 103a˜103c. To be more specific, the Web server 101e provides, on the Internet, Web pages described in a script language such as HTML (Hyper Text Markup Language) and XML according to a protocol such as HTTP, or provides, on digital broadcasting, pages described in BML (Broadcasting Markup Language) standardized by ARIB.

The network 102 is a network for connecting the distribution center 101 and the content using apparatuses 103a˜103c or the store 104 with each other. For example, the network 102 is a communication network such as the Internet, digital broadcasting, or a combined network of these.

Each of the content using apparatuses 103a˜103c, having a function of connecting to the network 102, is a terminal apparatus for a user to use contents on its monitor screen or write the contents onto a storage medium. To be more specific, each of the content using apparatuses 103a˜103c is a content display apparatus or a recorder such as an STB (Set top Box), a digital TV, a D-VHS, a DVD (Digital Versatile Disc) recorder and a PC (Personal Computer), or a combined apparatus of these.

The store 104 is an actual store where a service terminal 104a (so-called a kiosk terminal) for selling contents and electronic value is placed, such as a convenience store or a station kiosk.

The service terminal 104a offers a service of writing contents and electronic value onto a portable media such as an SD (Secure Digital) card and a memory stick. Note that the service terminal 104a is also connected to the network 102 to receive contents and licenses distributed from the distribution center 101 or send credit card numbers to the distribution center 101 for billing.

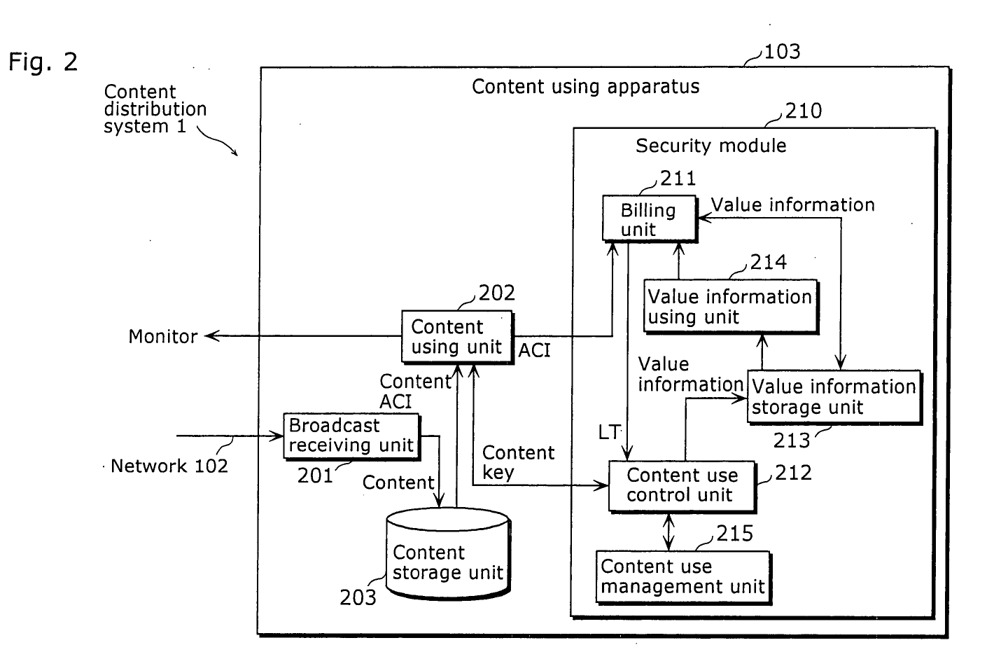

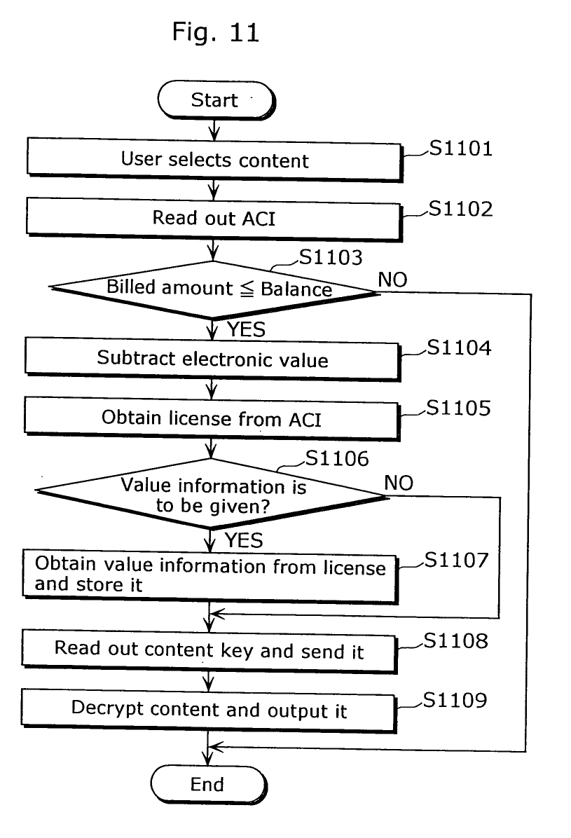

An example where contents are distributed by digital broadcasting in the content distribution system 1 as described above will be explained with reference to FIG. 2˜FIG. 11.

FIG. 2 is a functional block diagram showing the structure of the content using apparatus 103a, 103b or 103c as shown in FIG. 1. However, the detailed structure of the distribution center 101 in FIG. 1 is omitted because it is not the central feature of the present invention. Note that as a typical example of the functional structure of the content using apparatuses 103a˜103c, the content using apparatus 103a is illustrated as a content using apparatus 103. Also, the network 102 is indicated in this figure.

The content using apparatus 103, having a security module 210 that is a tamper-resistant hardware, includes a broadcast receiving unit 201, a content using unit 202, a content storage unit 203, a billing unit 211, a content use control unit 212, a value information storage unit 213, a value information using unit 214 and a content use management unit 215, and particularly the billing unit 211, the content use control unit 212, the value information storage unit 213, the value information using unit 214 and the content use management unit 215 which require security are realized as internal units of the security module 210.

The security module 210 includes a CPU, a RAM, a ROM, an EEPROM (Electrically Erasable Programmable ROM), a flash memory or the like, and the billing unit 211, the content use control unit 212, the value information storage unit 213, the value information using unit 214, and the content use management unit 215 are realized by the program stored in the ROM or the like in the security module 210 and executed using the CPU, RAM, EEPROM, flash memory or the like.

The broadcast receiving unit 201 is a unit for capturing MPEG-2 TS of digital broadcasting as an input stream into the content using apparatus 103.

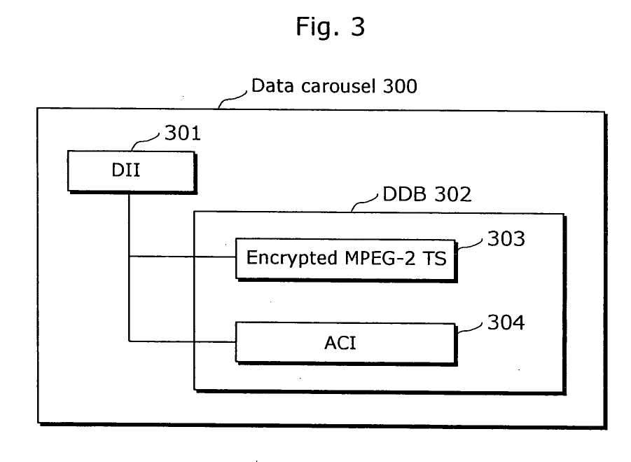

Here, contents which are distributed via digital broadcasting are contents based on a data carousel transmission system as shown in ARIB STD-B24, which is not stream broadcasting for real-time listening and viewing but storage (file) broadcasting which is stored in a storage medium such as an HDD. FIG. 3 shows a rough structure of a file content based on this data carousel transmission system.

As shown in FIG. 3, the data carousel 300 is comprised of a DII (Download Info Indication) 301 and a plurality of DDBs (Download Data Blocks) 302 that are divisions of a single or a plurality of files (modules) distributed by the data carousel 300. The files distributed by the data carousel 300 in the present embodiment are encrypted MPEG-2 TS 303 that is a content encrypted by AES or the like and ACI (Access Control Information) 304 including billing information, a content license, value information and others.

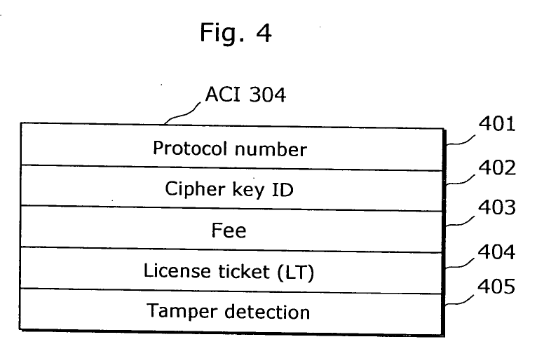

FIG. 4 is a diagram showing an example of the structure of ACI 304. The ACI 304 is comprised of a protocol number 401 that is a code for identifying the type of information included in the ACI 304, the length of each information, the overall structure of the ACI 304 and others, a cipher key ID 402 that is a code for identifying the decryption key of the ACI 304, a fee 403 indicating a billed amount of a content, a license ticket (LT) 404 including the cipher key (content key), usage rules and others as a license for the content, and a tamper detection 405 for detecting tampering with the ACI 304 using SHA-1 (Secure Hash Algorithm 1) or the like. The fee 403, the LT 404, the tamper detection 405 are encrypted with a key which is same as the key held by the billing unit 211 in advance under a contract or the like with a service provider, and then distributed. Note that the specific structure of the LT will be explained later in detail.

The broadcast receiving unit 201 receives such a digital broadcasting TS, and extracts, from the received TS, TS packets in a data carousel with reference to PIDs (Packet IDs) in the headers of the TS packets. To be more specific, the broadcast receiving unit 201 obtains the PIDs of the TS packets that make up the data carousel with reference to PSI (Program Specific Information) called PAT (Program Association Table) or PMT (Program Map Table). Then, the broadcast receiving unit 201 compares them with the PIDs in the headers of the TS packets in the received transport stream and separates the TS packets in the data carousel from other TS packets. The broadcast receiving unit 201 further restructures the DDI 301 and the DDB 302 from the separated TS packets in the data carousel and restructures each file (module) from the DDB 302.

The content using unit 202 reads out an encrypted content stored in the content storage unit 203, decrypts the encrypted content with a content key obtained from the content use control unit 212, decodes the content, and outputs it to a monitor or the like not shown in the figure. After the content use is ended, the content using unit 202 sends the use end notice to the content use control unit 212 to complete the content use. Generally, the content using unit 202 is realized by a tamper-resistant hardware such as an LSI or the like in order to prevent unauthorized uses by malicious users.

The content storage unit 203 is a unit for storing the contents and the information such as the ACI 304 received from the broadcast receiving unit 201, and is generally realized by an HDD (Hard Disk Drive) or the like. The contents or the like are stored in the content storage unit 203 by users' actions, or automatically stored by the content using apparatus 103.

The billing unit 211 is a unit for performing billing processing using electronic value. To be more specific, for the billing processing, the billing unit 211 obtains the balance in electronic value held in the value information storage unit 213 and subtracts the electronic value corresponding to the billed amount. Note that if a part or the entire of the ACI 304 is encrypted, the billing unit 211 performs decryption processing using a decryption key which is held in advance under the contract with the service provider or the like before performing the subsequent processing. This decryption key held in advance is distributed via EMM (Entitlement Management Message) or the like.

The content use control unit 212 controls content use based on the license (LT) of the content. To be more specific, when a user requests a use of a content, the content use control unit 212 obtains a LT after the billing processing by the billing unit 211, and judges whether the content can be used or not based on the usage rules included in the LT. Only if the usage rules permit the use of the content, the content use control unit 212 passes a content key for decrypting the encrypted content to the content using unit 202. SAC (Secure Authenticated Channel) is established between the content use control unit 212 and the content using unit 202 for secure transmission of a content key.

The content use control unit 212 controls content use and, at the same time, gives value information to users according to their content use. To be more specific, the content use control unit 212 gives value information included in a license when a certain rule is satisfied and stores it in the value information storage unit 213. Here, a certain rule means a case where a specific content is used, a case where a plurality of specific contents are all used, or the like. Also, this rule is described in value information itself, or held in advance by the content use control unit 212. In the present embodiment, a case where the content use control unit 212 determines whether to give value information or not under the rule described in the value information itself will be explained.

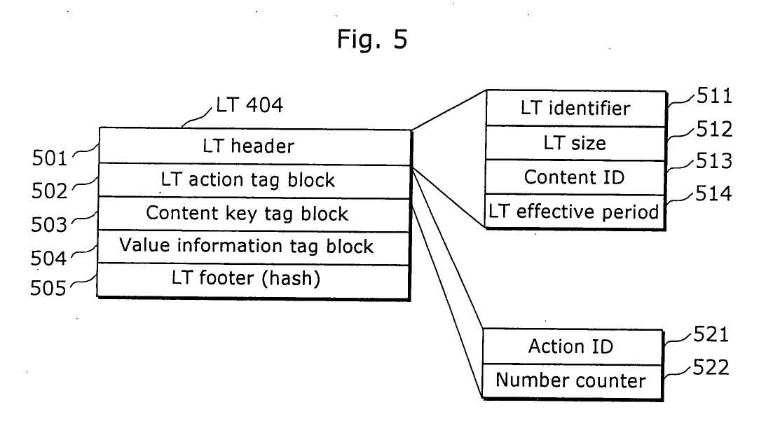

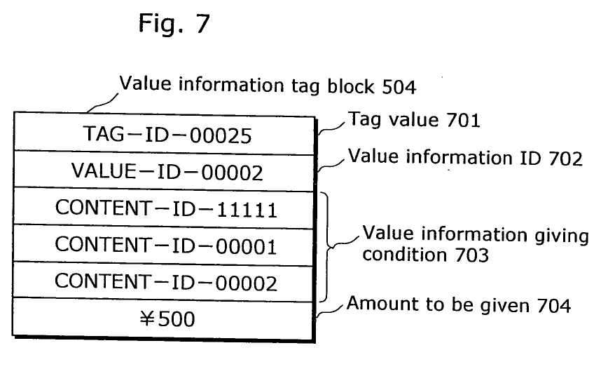

Here, the structures of a LT and value information handled by the content use control unit 212 will be explained in detail with reference to FIG. 5˜FIG. 7.

FIG. 5 is a diagram showing an example of a structure of a LT 404. The LT 404 is comprised of a LT header 501 including a content ID, an expiration date of a LT of a content whose use is permitted by the LT, or the like, a LT action tag block 502 indicating the content usage rules such as a permitted number of reproductions and a permitted number of copies of the content, a content key tag block 503 including a cipher key (a content key) for decrypting the content, a value information tag block 504 including value information, and a LT footer 505 that is a hash value for detecting tampering of the LT.

The LT header 501 is comprised of a LT identifier 511 for identifying the LT, a LT size indicating the entire length of the LT, a content ID 513 that is an identifier of the content whose use is permitted by the LT and a LT effective period 514 indicating the LT effective period.

Further, the LT action tag block 502 is comprised of an action ID 521 for specifying a user's action for the content such as “reproduction”, “copying” and “printing” and a number counter 522 indicating a permitted number of executions of the action.

The LT footer 505 is something for detecting tampering of the LT and securing the validity of the LT when storing the LT in an unsecure area such as a hard disk, and calculates the hash value of the LT every time the LT is updated and manages the calculation results. Secure management of hash values are achieved only by storing the hash values in the security module 210. As a specific hash algorithm, SHA-1 or the like is used.

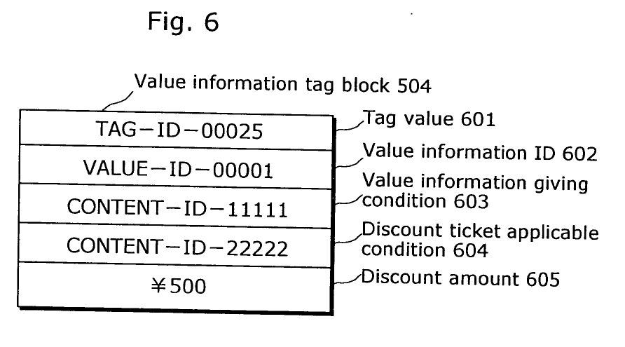

FIG. 6 and FIG. 7 show examples of the structures of the value information tag block 504.

FIG. 6 is an example showing a discount ticket as value information, and the value information tag block 504 is comprised of a tag value 601, a value information ID 602, a value information giving condition 603, a discount ticket applicable condition 604 and a discount amount 605.

The tag value 601 is a value for indicating a value information tag block, and “TAG-ID-00025” is set for it.

The value information ID 602 is a value indicating a type of the value information, and “VALUE-ID-00001” indicating a discount ticket is set as the value information.

In the value information giving condition 603, a condition for giving the discount ticket for the user is described. In other words, the discount ticket is given to the user when the condition described in the value information giving condition 603 is satisfied. In the case of FIG. 6, the discount ticket is given when “CONTENT-ID-11111” is used. Therefore, when the value information as shown in FIG. 6 is added to the content with its content ID “CONTENT-ID-11 μg” for distribution, processing of giving the value information when the content is used is performed. It is assumed that the content ID as meta-data is assigned to the content itself, and the meta-data is added as header information or added as an electronic watermark.

In the discount ticket applicable condition 604, a condition applicable to the discount ticket in a case where the discount ticket is used after being obtained is described. In other words, the user can purchase at a discount price using the discount ticket on the billing processing, only if the discount ticket applicable condition is satisfied. In FIG. 6, as an example of the discount ticket applicable condition, the content ID “CONTENT-ID-22222” is set, so the user can use the discount ticket only when purchasing the content with its content ID “CONTENT-ID-22222”.

The discount amount 605 is a value indicating the discount amount of the discount ticket, and “500 yen” is set here. Therefore, if the discount ticket is obtained and the discount ticket applicable condition 604 is satisfied, the user can purchase the content at a discount price by 500 yen as indicated in the discount amount 605.

On the other hand, FIG. 7 is an example showing a case where value information is electronic value, and the value information tag block 504 is comprised of a tag value 701, a value information ID 702, a value information giving condition 703 and an amount to be given 704.

The tag value 701 is a value for indicating a value information tag block, and “TAG-ID-00025” is set for it.

The value information ID 702 is a value indicating a type of value information, and “VALUE-ID-00002” indicating electronic value is set as value information.

In the value information giving condition 703, a condition for giving the electronic value is described. In other words, processing of giving value information to a user is performed if the condition described in the value information giving condition 703 is satisfied. In FIG. 7, three contents “CONTENT-ID-11111”, “CONTENT-ID-00001” and “CONTENT-ID-00002” are described as the value information condition 703, the electronic value is given to the user only when he uses all the three contents.

The amount to be given 704 is a value indicating the amount of the electronic value to be given, and “500 yen” is set here. Therefore, when the user satisfies the value information giving condition 703, the electronic value of “500 yen” set for the amount to be given 704 is given to the user.

Detailed structures of a LT and value information have been explained with reference to FIG. 5˜FIG. 7.

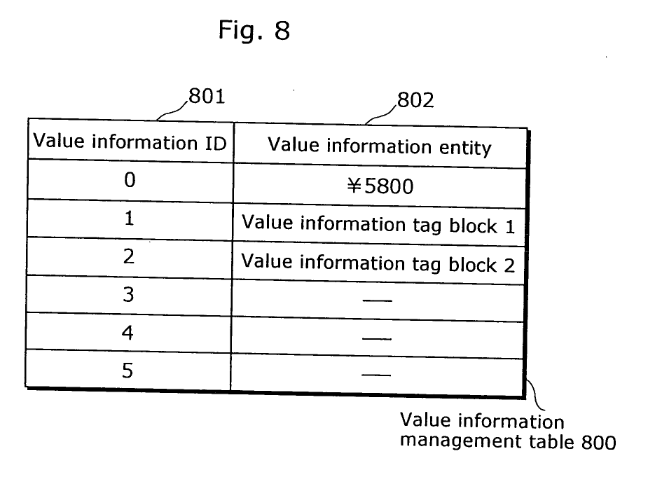

The value information storage unit 213 stores the value information received from the content use control unit 212. To be more specific, the value information storage unit 213 stores the discount ticket as shown in FIG. 6 as it is as value information, or adds the electronic value as shown in FIG. 7 to the balance in electronic value owned by a user. When the user purchases electronic value prepaid via the service terminal, the Internet or the like, the value information storage unit 213 adds the purchased electronic value. Here, FIG. 8 shows an example of a value information management table held by the value information storage unit 213.

The value information management table 800 is comprised of a value information ID 801 and a value information entity 802.

The value information ID 801 is an ID for identifying uniquely each value information in the content using apparatus 103, that is, an ID which is assigned by the value information storage unit 213 appropriately so as to be unique. This value information ID 801 can also be assigned so as to be globally unique in a system. Using the value information ID 801, a user can specify value information he would like to use.

The value information entity 802 stores actual value information. As for data stored in the value information entity 802, an example where a value information tag block itself is stored is shown here, as indicated in the records of a value information ID=1 and a value information ID=2. Among the value information tag block, only minimum information required, for example, in a case of a discount ticket of FIG. 6, only a value information ID 602, a discount ticket applicable condition 604 and a discount amount 605, may be stored, of course. Note that the record of a value information ID=0 is used as a user's electronic wallet, which is an example of a special record. The electronic value obtained by the user is added to the field of the value information entity 802 of the value information ID=0, and the electronic value used by the user is subtracted from the field of the value information entity 802 of the value information ID=0.

As for prepaid purchase of electronic value, it is assumed here that electronic value is purchased on the service terminal 104a placed in the store 104 such as a convenience store and a station kiosk. For example, a user goes to the store 104 with the security module 210 and purchases an electronic value of 5000 yen by cash, a credit card function or the like of the security module 210 on the service terminal 104a. Then, the electronic value of 5000 yen is written in the value information storage unit 213 of the security module 210. Using this electronic value, the user can purchase contents on an STB or the like in his home. As mentioned above, carrying the security module 210 having electronic value allows purchase and use of contents, irrespective of communication environments or places.

The value information using unit 214 is a unit for using value information stored in the value information storage unit 213. To be more specific, the value information using unit 214 passes a discount ticket stored in the value information storage unit 213 to the billing unit 211 to purchase a content at a discount price, or passes electronic value managed by the value information storage unit 213 to the billing unit 211.

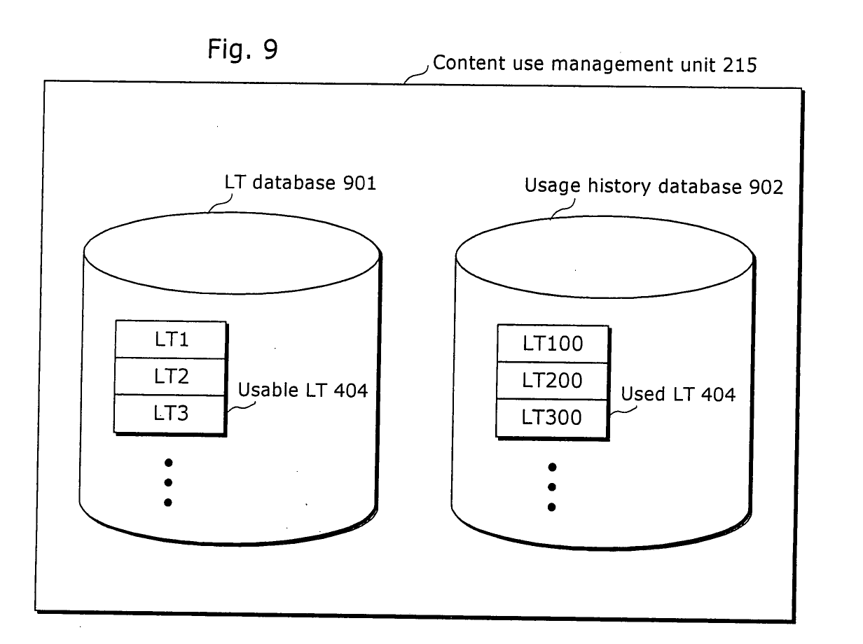

The content use management unit 215 is a unit for managing usage histories of LTs and contents. To be more specific, the content use management unit 215 has a LT database 901 for managing LTs 404 which can be used (usable LTs) and a usage history database 902 for managing the LTs 804 which have been used (used LTs), as shown in FIG. 9, and passes a LT to the content use control unit 212 or notifies it of whether there is any used LTs or not as a usage history, upon request from the content use control unit 212.

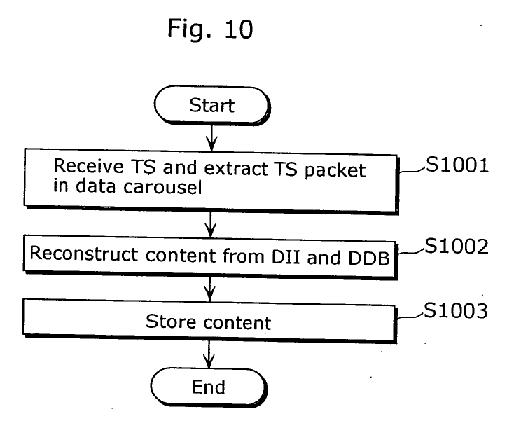

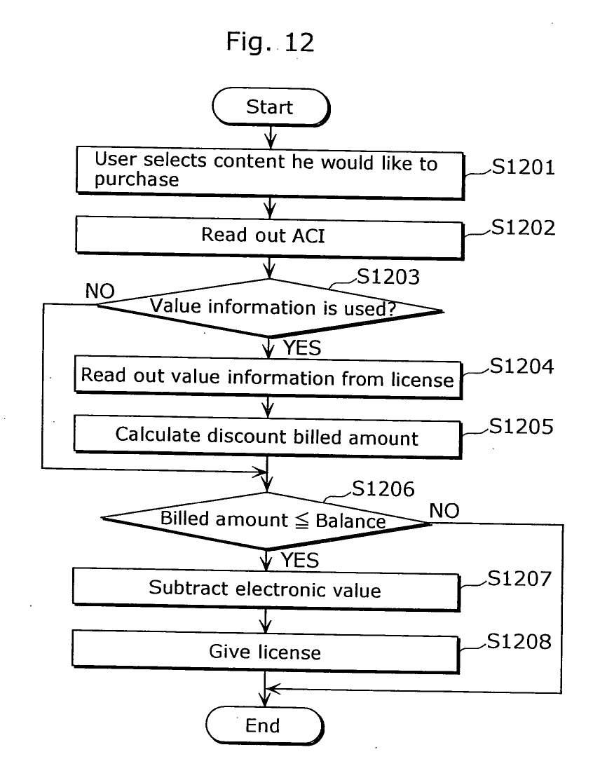

A sequence of operations conducted by the content using apparatus 103 structured as above: storing contents obtained from digital broadcasting in the content storage unit 203; a user's purchasing and using the stored contents; and obtaining value information according to his content use and using the value information, will be explained with reference to flowcharts as shown in FIG. 10˜FIG. 12.

First, the operation of the content using apparatus 103 to store contents of digital broadcasting in the content storage unit 203 will be explained using the flowchart as shown in FIG. 10.

The broadcast receiving unit 201 selects a necessary TS from the received broadcast signal based on a user's storage reservation or a program as an automatic storage function, and extracts TS packets in a data carousel (Step S1001).

The broadcast receiving unit 201 reconstructs DII 301 and DDB 302 from the extracted TS packets in the data carousel (Step S1002), and writes modules reconstructed from the DII 301 and the DDB 302 into the content storage unit 203 (Step S1003).

In the above manner, storage contents distributed by digital broadcasting are stored in the content storage unit 203 of the content using apparatus 103.

Next, the operations of the content using apparatus 103 from a user's use of a content until obtainment of value information will be explained using the flowchart as shown in FIG. 11.

A user selects a content he would like to use from among a list of contents stored in the content storage unit 203 using a user interface unit not shown in FIG. 2 (Step S1101).

The content using unit 202 searches the content storage unit 203 for the content selected by the user, and obtains ACI 304 corresponding to the content (Step S1102). To be more specific, if the user selects an encrypted content he would like to use, namely an encrypted MPEG-2 TS 303, the ACI 304 associated with the encrypted MPEG-2 TS 303 is read out from the content storage unit 203.

The billing unit 211 compares the billed amount and the balance of the electronic value held in the value information storage unit 213 to judge whether the user can purchase the content or not (Step S1103).

More specifically, the billing unit 211 reads out the balance of the electronic value stored in the value information storage unit 213, and compares the balance with the billed amount described in the fee 403 of the obtained ACI 304. If the ACI 304 is encrypted, the subsequent processing is performed after decrypting the encrypted portion of the ACI 304, while if the tamper detection is set, the subsequent processing is performed after making sure that no tampering is detected.

In a case of YES in Step S1103, namely, when the billed amount is the balance of the electronic value or less, it is judged that the user can purchase the content, and Step S1104 is executed.

In a case of NO in Step S1103, namely, when the billed amount is larger than the balance of the electronic value, it is judged that the user cannot purchase the content, and thus the judgment is notified to the user and the present processing is ended.

If it is judged in Step S1103 that the user can purchase the content, the billing unit 211 subtracts the billed amount from the balance of the electronic value, and updates the balance of the electronic value (Step S1104).

After completing billing, the billing unit 211 obtains the LT 404 from the ACI 304, and sends it to the content use control unit 212 (Step S1105).

The content use control unit 212 stores the LT 404 received from the billing unit 211 in the content use management unit 215. Upon receipt of the instruction to start content use from the content using unit 202, the content use control unit 212 analyzes the LT 404 obtained from the content use management unit 215, and judges whether to give value information to the user or not (Step S1106). To be more specific, it checks whether the value information is added to the LT 404 or not, and if the value information is added to the LT 404, it checks the value information giving condition in the value information tag block 504 of the LT 404 and judges whether the condition for giving the value information is satisfied or not.

For example, when the content ID 513 in the LT header 501 of the LT 404 is “CONTENT-ID-11111”, namely, when the content ID of the encrypted MPEG-2 TS 303 is “CONTENT-ID-11111”, the condition for giving the value information is satisfied at the time point of using the LT 404 because “CONTENT-ID-11111” is described in the value information giving condition 603 in the example of FIG. 6, and thus the discount ticket as shown in FIG. 6 is given as value information.

Or, as shown in FIG. 7, three contents “CONTENT-ID-11111”, “CONTENT-ID-00001” and “CONTENT-ID-00002” can be specified as the value information giving condition 703. In this case, using the content use management unit 215, the content use control unit 212 judges to give value information only when all of these three contents are used. To be more specific, since the LT database 901 and the usage history database 902 of the content use management unit 215 store the usable LTs and used LTs respectively, the content use control unit 212 inquires of the content use management unit 215 about whether or not there exist the content IDs described in the value information giving condition 703, using these IDs as keys. After searching the LT database 901 or the usage history database 902, the content use management unit 215 can determine to give the electronic value as shown in FIG. 7 to the user as value information when all the LTs for the contents whose content IDs 513 in the LT headers 501 “CONTENT-ID-11111”, “CONTENT-ID-00001” and “CONTENT-ID-00002” exist, and not to give the value information when even one of these does not exist.

In a case of YES in Step S1106, namely, when the condition for giving value information is satisfied, Step S1107 is executed.

In a case of NO in Step S1106, namely, when the condition for giving value information is not satisfied, Step S1108 is executed.

Note that Step S1108 is executed if value information is not added to the LT 404.

The content use control unit 212 obtains the value information included in the value information tag block 504 from the LT 404, and writes the obtained value information into the value information storage unit 213 (Step S1107).

To be more specific, the content use control unit 212 obtains the discount ticket as shown in FIG. 6 that is the value information from the LT 404, and additionally stores it in the value information storage unit 213. Or, the content use control unit 212 obtains the electronic value as shown in FIG. 7, and adds it to the balance of the electronic value in the value information storage unit 213.

Next, the content use control unit 212 reads out a content key in the content key tag block 503 from the LT 404, and sends it to the content using unit 202 (Step S1108).

To be more specific, the content use control unit 212 obtains a content key included in the content key tag block 503 of the LT 404, and passes the content key to the content using unit 202 via the SAC established between them. It also updates the LT action tag block 502 of the LT 404, and stores the updated LT 404 in the content use management unit 215 again. Here, the updating of the LT action tag block 502 means the processing of decrementing the number counter 522 to update to “2” if the action ID 521 in the LT action tag block 502 is “reproduction” and the number counter 522 indicates “3”, for example.

The content using unit 202 decrypts the encrypted content with the content key received from the content use control unit 212 to reproduce it (Step S1109).

More specifically, the content using unit 202 receives the content key from the content use control unit 212 and reads out the corresponding content from the content storage unit 203. Since the payloads of the TS packets in the content are encrypted with the content key, MPEG decoding is executed while decrypting the content with the obtained content key so as to reproduce the content.

A storage content is purchased and then used under license in the manner as described above, and, at the same time, value information is stored in the value information storage unit 213.

Finally, operations of using the obtained value information for billing in the content using apparatus 103 will be explained using the flowchart as shown in FIG. 12.

The user selects a content he would like to use from among the list of contents stored in the content storage unit 203 using a user interface unit not shown in FIG. 2 (Step S1201). At this time, the user also inputs that he will use the discount ticket which has already been obtained. It is assumed that the content has the same structure as the storage content as shown in FIG. 3.

The content using unit 202 searches the content storage unit 203 for the content selected by the user, and obtains the ACI 304 corresponding to the content (Step S1202). To be more specific, when the user selects the content he would like to use, the content storage unit 203 reads out the ACI 304.

The billing unit 211 checks whether or not the user specifies that he will use the value information (Step S1203).

More specifically, when the user uses the value information such as a discount ticket, the content using unit 202 passes the ACI 304 and the value information ID for identifying the value information specified by the user to the billing unit 211, and thus the billing unit 211 performs the processing of confirming the value information corresponding to this value information ID. Note that this value information ID is an ID for identifying each value information uniquely in the content using apparatus 103, and appropriate unique value may be allocated to the ID when the value information is stored in the value information storage unit 213.

In a case of YES in Step S1203, namely, when the value information is used, Step S1204 is executed.

In a case of NO in Step S1203, namely, when the value information is not used, Step S1206 is executed.

It is judged in Step S1203 that the value information is used, the value information using unit 214 obtains the value information of the corresponding value information ID from the value information storage unit 213 and uses it (Step S1204).

More specifically, the value information using unit 214 searches for the value information in the value information storage unit 213 using the value information ID as a key, and reads out the discount ticket that is the corresponding value information. The value information using unit 214 sends the read-out discount ticket to the billing unit 211.

The billing unit 211 calculates the discount billed amount in a case where the discount ticket is used as value information (Step S1205).

More specifically, the billing unit 211 subtracts the discount amount described in the discount ticket from the billed amount described in the fee 403 of the ACI 304 to calculate the discount billed amount. For example, if the fee described in the ACI 304 is “1000 yen” and the discount amount described in the discount ticket is “300 yen”, the discount billed amount “700 yen” is calculated.

The calculated discount billed amount is compared with the balance of the electronic value read out from the value information storage unit 213 to judge whether the user can purchase the content or not (Step S1206).

In a case of YES in Step S1206, namely, when the billed amount is the balance of the electronic value or less, it is judged that the user can purchase the content, and Step S1207 is executed.

In a case of NO in Step S1206, namely, when the billed amount is larger than the balance of the electronic value, it is judged that the user cannot purchase the content, and the judgment is notified to the user. The value information using unit 214 stores the discount ticket in the value information storage unit 213 again, and ends this processing.

If it is judged in Step S1206 that the user can purchase the content, the billing unit 211 subtracts the billed amount from the balance of the electronic value to update the balance of the electronic value (Step S1207).

After completing billing, the billing unit 211 fetches the LT 404 from the ACI 304, and sends it to the content use control unit 212 (Step S1208). At the same time, the value information using unit 214 erases the used discount ticket.

Note that the processing on the content using unit 202 of decrypting a content with a license key obtained from a LT and outputting it is omitted here because the processing is same as Steps S1108 and S1109 in FIG. 11.

The value information obtained by the user in the manner as mentioned above can be used as a discount ticket or electronic value.

Note that in the present embodiment, a case of distributing storage contents by digital broadcasting has been explained, but the same method can be applied to a case of distributing stream contents by digital broadcasting if LTs and value information are included in an ECM (Entitlement Control Message) or the like, instead of the ACI 304.

Note that in the present embodiment, it is judged in Step 51206 that a user cannot purchase a content if the balance of the electronic value in the value information storage unit 213 is less than the billed amount, but the content using apparatus 103 may notify the user of the judgment and recommends the user to purchase the additional electronic value. In this case, if the user accepts the purchase of the additional electronic value, the content using apparatus 103 performs the processing of purchasing the additional electronic value via communication with the distribution center 101.

As described above, in the content distribution system 1, value information such as an electronic ticket and electronic value can be given to users depending on their content use, and the value information can be used for billing in a manner such as a discount, and thus flexible services can be realized.

(Second Embodiment)

The second embodiment of the present invention will be explained below with reference to the drawings.

In the second embodiment of the present invention, an example of streaming distribution of contents via a broadband network such as ADSL (Asymmetric Digital Subscriber Line) and FTTH (Fiber To The Home) using a streaming protocol such as RTP will be described.

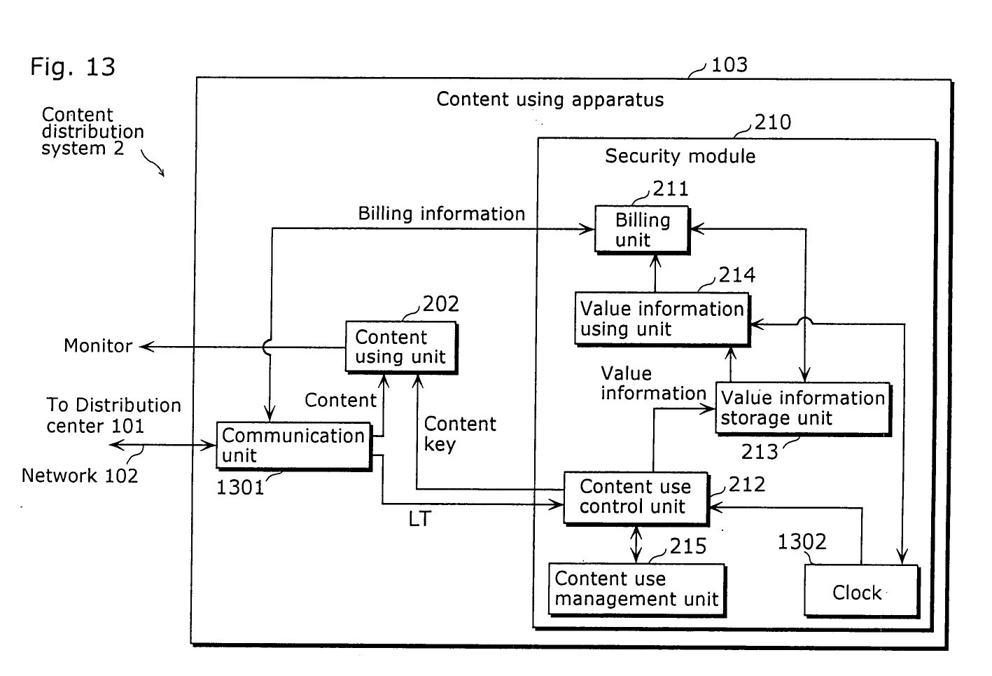

FIG. 13 is a block diagram showing the structure of the content using apparatus 103 according to the second embodiment of the present invention. In this figure, the same reference numbers as those in FIG. 2 are assigned to the same components as those in the content using apparatus 103 of the first embodiment in FIG. 2, and the explanation thereof is omitted. Also, the general view of the rough structure of the present content distribution system of the second embodiment is same as that of the content distribution system 1 as shown in FIG. 1, but will be explained assuming that it is the re-defined content distribution system 2.

The content using apparatus 103 in FIG. 13 includes a communication unit 1301 for communicating with the distribution center 101 via the network 102, instead of the broadcasting receiving unit 201 in FIG. 2. To be more specific, the communication unit 1301 gives and receives contents and licenses between the distribution center 101 and the content using apparatus 103 using a protocol such as TCP/IP.

In addition to the structure of FIG. 2, the content using apparatus 103 includes a clock 1302 in the security module 210. To be more specific, the clock 1302 manages the time on the content using apparatus 103 securely, and cannot be easily changed by a user. Time difference between the content using apparatus 103 and the distribution center 101 can be compensated by applying the time compensation algorithm or the like similar to NTP (Network Time Protocol) to them via the SAC.

Also, since contents are distributed by streaming from the distribution center 101 in the second embodiment, the content storage unit 203 in the content using apparatus 103 in FIG. 2 is omitted here.

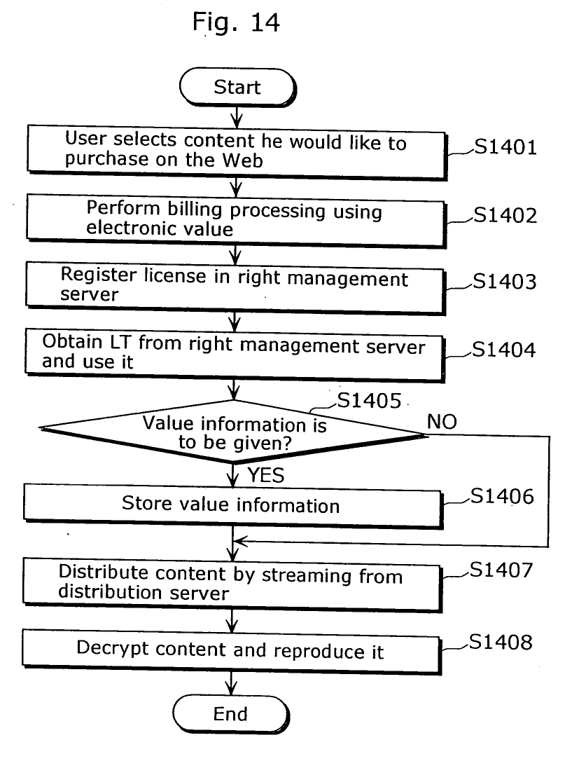

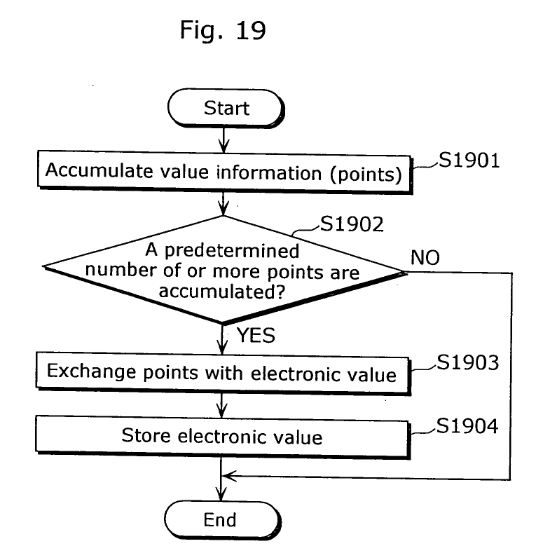

A sequence of operations conducted by the content using apparatus 103 structured as above: purchasing a license for a content from the distribution center 101 via communication, using the content distributed by streaming, obtaining value information depending on the content use, and using the value information, will be explained with reference to the flowcharts and structural diagrams as shown in FIG. 14˜FIG. 19.

First, the operations of the content using apparatus 103 to purchase a license for a content from the distribution center 101 via communication, use the content distributed by streaming and obtain value information will be explained with reference to the flowchart as shown in FIG. 14.

The content using apparatus 103 selects a content whose license is to be purchased on a license purchase screen provided by the Web server 101e by a user's operation via a user interface unit (not shown in FIG. 13) such as a Web browser (Step S1401).

The billing unit 211 performs billing processing for the purchase of the content selected in Step S1401 using electronic value (Step S1402). To be more specific, the billing unit 211 communicates with the Web server 101e (or the billing server 101a) in the distribution center 101, that is, a Website for selling licenses for contents, and obtains the price (the fee or the billed amount) of the selected content. Then, the billing unit 211 performs the processing of subtracting the electronic value corresponding to the billed amount from the balance of the electronic value stored in the value information storage unit 213. Note that the user's electronic value stored in the value information storage unit 213 can be purchased prepaid, by means of a credit card, direct debit or the like, in the distribution center 101 via the network 102.

After completing the billing processing in Step S1402, the license for the content purchased by the user is registered in the right management server 101b (Step S1403). To be more specific, after completing the billing processing, the billing unit 211 notifies the billing server 101a of the completion, and thus the license for the purchased content is registered in the right management server 101b. The billing unit 211 can notify the billing server 101b of the completion of the purchase, by means of a digital signature such as an RSA (Rivest, Shamir and Adleman) signature on data such as an electronic receipt for certifying the completion of the purchase, for example. Or, the billing unit 211 can notify the completion of the purchase directly via SAC. Note that since the data notifying the completion of the purchase includes an ID for identifying the user, a content ID for identifying the content purchased by the user or an ID for identifying the unit of the purchase, the right management server 101b can register the license for the content purchased by the user in the database for managing the usage rights held by the right management server 101b.

When a user uses a content purchased under license, he downloads the LT of the content owned by the user from the right management server 101b (Step S1404). To be more specific, the content use control unit 212 of the content using apparatus 103 sends a LT issue request to the right management server 101b, and can obtain the LT generated in the right management server 101b if the right management server 101b can confirm that the user holds the license.

The content use control unit 212 analyzes the LT received from the communication unit 1301 and judges whether to give the value information to the user or not (Step S1405).

More specifically, the content use control unit 212 checks whether the value information is added to the LT or not, and then checks the value information giving condition in the value information tag block 504 of the LT 404 as shown in FIG. 5 if the value information is added to the LT so as to judge whether the condition for giving the value information is satisfied or not.

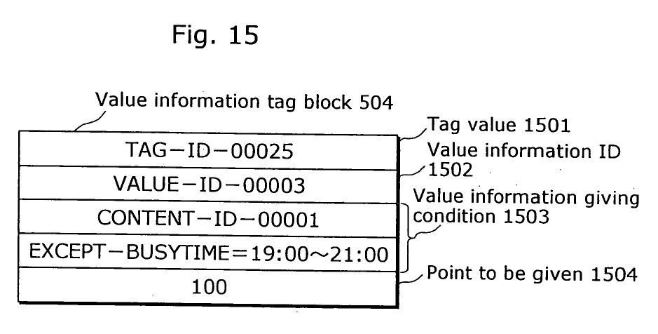

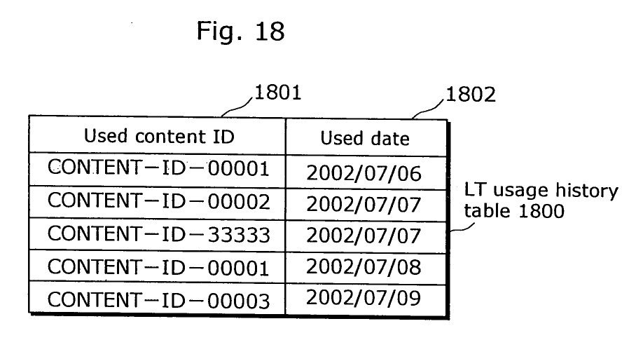

Here, the processing in Step S1405 will be explained in detail with reference to FIG. 15˜FIG. 18.

In the present embodiment, it is assumed that a condition for giving value information to a user is that he uses a streaming content in a time of a day other than a busy time. That is because LTs for allowing the use of the contents are obtained when the contents are used by streaming, and thus access to the server may concentrate to the busy time to put heavier load on the server. Therefore, this condition is set in order to distribute the load on the server by giving the value information to the users who use the contents in the time of a day other than the busy time.

Here, it is assumed that the value information is point information which can be exchanged with other value information such as a license, a content, electronic value if certain points of value information is accumulated. FIG. 15 shows an example of point information.

Value information indicating point information is comprised of a tag value 1501, a value information ID 1502, a value information giving condition 1503 and a point to be given 1504.

The tag value 1501 is “TAG-ID-00025” indicating the value information tag block, and the value information ID 1502 is “VALUE-ID-00003” indicating point information. In the value information giving condition 1503, conditions for giving point information to a user via the content control unit 212 are described. Here, “CONTENT-ID-00001” and “EXCEPT-BUSYTIME=19:00˜21:00” are described in this value information giving condition 1503. This means that the value information is given if the LT of “CONTENT-ID-00001” is used in the time of a day other than the busy time of 19:00˜21:00. The point to be given 1504 is the points which are given by the content use control unit 212 (100 points In this example). This point information can be exchanged with other value information if a certain number of points, for example, 1000 points, are accumulated.

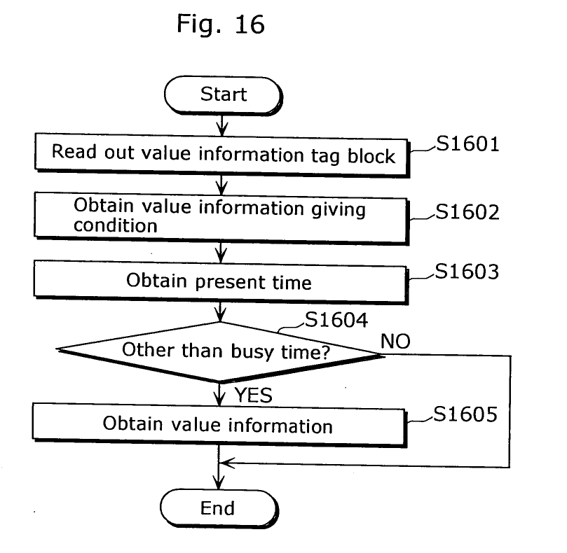

Here, FIG. 16 is a flowchart showing in detail the operation of the content use control unit 212 to judge whether to give value information to a user or not in Step S1405 in FIG. 14.

The content use control unit 212 reads out the value information tag block 504 of the LT (Step S1601). To be more specific, the content use control unit 212 searches the LT 404 for a tag block of “TAG-ID-00025” and obtains the value information tag block 504 as shown in FIG. 15.

The content use control unit 212 reads out the value information giving condition 1503 in the value information tag block 504 (Step S1602). To be more specific, the content use control unit 212 obtains the value information giving condition 1503, “CONTENT-ID-00001” and “EXCEPT-BUSYTIME=19:00˜21:00” from the value information tag block 504.

The content use control unit 212 obtains the present time (Step S1603), and judges whether or not the present time is included in a time of a day other than the busy time (Step S1604). To be more specific, the content use control unit 212 obtains the present time from the clock 1302, and judges whether the present time is included in the time period of “19:00˜21:00” or not.

In a case of YES in Step S1604, namely, when the present time is included in the time of a day other than the busy time, Step S1605 is executed.

In a case of NO in Step S1604, namely, when the present time is included in the busy time, the user cannot obtain the value information, and the processing is ended.

When the present time is included in the time of a day other than the busy time, the point information is given as value information (Step S1605). To be more specific, the content use control unit 212 obtains the point Information of “100 points” from the point to be given 1504 in the value information tag block 504.

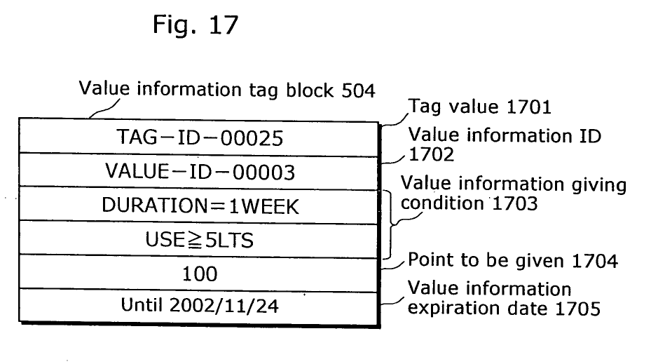

In the above explanation, the value information is given when the content is used in a time of a day other than a busy time, but the value information can also be given to users who used a predetermined or more amount of contents in a predetermined period of time, namely, for heavy users. FIG. 17 shows an example of the structure of the value information tag block 504 in this case.

In FIG. 17, “DURATION=1WEEK” and “USE≧5LTS” are described in the value information giving condition 1703 of the value information tag block 504, namely, the condition meaning that value information is given if 5 or more LTs are used within 1 week” is set.

Also, in FIG. 17, as shown in a value information expiration date 1705, an expiration date of value information can be set. Here, it is shown that the value information is effective until “2002/11/24”. The value information using unit 214 obtains the time from the clock 1302, and performs the processing of using the value information when the time is before the expiration date as shown in the value information expiration date 1705, but handles the value information as ineffective when the time has passed the expiration date.

Note that in the value information expiration date 1705, the expiration date set for each value information may be extended if a certain condition is satisfied. For example, the expiration date of the value information may be extended when a user continues to watch a certain program. This certain condition may be described in the value information itself, or may be held in advance by the content using apparatus 103.

FIG. 9 shows a case where used LTs are stored in a database (usage history database 902) as a usage history, but the used LTs may be managed as a LT usage history table 1800 as shown in FIG. 18, not as the LTs themselves. In the LT usage history table 1800, a used content ID 1801 and a used date 1802 are recorded. The time obtained from the clock 1302 is used as the used date 1802. By doing so, the content use control unit 212 can determine whether to give the value information or not by inquiring the content use management unit 215 about whether a predetermined or more amount of contents have been used in a predetermined period of time. For example, the present date obtained from the clock 1302 is 2002/07/10, the value information giving condition 1703 as shown in FIG. 17 is satisfied because there exists the LT usage history of 5 records, and thus the processing of giving the value information (point to be given 1704) is performed.

In order to manage the LT usage histories based on the upper limit to the period stored on the LT usage history table 1800, the processing of setting the upper limit to the period for managing each history on the LT usage history table 1800 and deleting the applicable histories from the LT usage history table 1800 after a predetermined period of time has passed may be performed. Or, the LT usage histories may be managed based on the upper limit to the number of histories to be stored. For example, the upper limit to the number of LT usage histories stored in the LT usage history table 1800 is set, and if the number of histories exceeds the upper limit, they may be deleted from the LT usage history table 1800 in order of the length of the time stored.

The processing of judging whether to give value information or not in Step S1405 has been explained in detail with reference to FIG. 15˜FIG. 18.

The processing following Step S1406 in FIG. 14 will be explained below.

In a case of YES in Step S1405, namely, when the condition for giving value information is satisfied, Step S1406 is executed.

In a case of NO in Step S1405, namely, when the condition for giving value information is not satisfied, Step S1407 is executed.

Note that Step S1407 is executed when the value information is not added to the LT.

The content use control unit 212 obtains the value information from the LT, and writes the value information into the value information storage unit 213 (Step S1406). To be more specific, the content use control unit 212 obtains the point to be given 1704 that is value information from the LT 404 and additionally stores the point information in the value information storage unit 213.

After obtaining the LT, the distribution server 101c starts streaming of the content (Step S1407). To be more specific, the content using apparatus 103 sends a request to start streaming of the content using RTSP (Realtime Streaming Protocol) or the like, so as to start obtaining the streaming content from the distribution server 10c.

The content using unit 202 decrypts the encrypted content with a content key received from the content use control unit 212 to reproduce the content (Step S1408). To be more specific, the content using unit 202 receives a content key from the content use control unit 212 and executes MPEG decoding while decrypting the content distributed by streaming with the content key, so as to reproduce the content.

The content is purchased and then used under license in the manner as described above, and, at the same time, the value information is stored in the value information storage unit 213.

Here, the point information as value information obtained in FIG. 14 can be exchanged with electronic value, a license or a discount coupon, if a predetermined number of points are accumulated. FIG. 19 is a flowchart of the operation of exchanging a predetermined number of accumulated point information with electronic value.

When a user uses a content, the content use control unit 212 in FIG. 13 obtains point information from a LT and accumulates point information in the value information storage unit 213 if a condition for giving value information (point information) is satisfied (Step S1901).

The value information using unit 214 reads out the point information accumulated in the value information storage unit 213, and checks whether a predetermined number of or more point information, for example, 1000 points or more, have been accumulated or not (Step S1902).

In a case of YES in Step S1902, namely, when 1000 points or more of the point information have been accumulated, Step S1903 is executed.

In a case of NO in Step S1902, namely, when the accumulated points are less than 1000 points, the point information cannot be exchanged with electronic value, and thus the processing is ended.

The value information using unit 214 exchanges 1000 points with the electronic value (Step S1903). To be more specific, it subtracts 1000 points from the point information owned by the user, and exchanges it with the electronic value according to the exchange rate for the point information and the electronic value held in advance by the value information using unit 214. For example, when the exchange rate between the point information and the electronic value is 1 point to 1 yen in electronic value, 1000 points can be exchanged with electronic value of 1000 yen.

The value information using unit 214 stores the exchanged electronic value in the value information storage unit 213 (Step S1904). To be more specific, the value information using unit 214 adds the electronic value exchanged in Step S1903 to the balance of the electronic value in the value information storage unit 213 so as to update the balance of the electronic value, and calculates the remainder of the point information to update the value of the point information.

As for an exchange rate between point information and electronic value, an example where the value information using unit 214 holds in advance a fixed exchange rate has been explained here, but the distribution center 101 may update the exchange rate at an arbitrary timing, or a user may inquire the exchange rate of the distribution center 101 at every exchange. Or, it may be conceived that point information is sent to the distribution center 101, where it is exchanged with electronic value, and the electronic value is sent from the distribution center 101.

In FIG. 19, an example of exchanging point information earned as value information with electronic value has been described, but it can be conceived that the point information is exchanged with a LT or a discount ticket so as to use it for the next purchase of a content via communication or on a service terminal at a convenience store or the like. Or, it may be conceived that a user exchanges point information with a premium content or a LT of the premium content which is available only to a user who accumulated the point information. When exchanging the point information with the LT, the content use control unit 212 may generate the LT, or the point information may be sent to the distribution center 101 so as to distribute the LT generated in the right management server 101b. Or, point information is not only exchanged with a new LT, but an amount of content use under the usage rules of the existing LT may be increased.

Furthermore, an example where specific conditions of using a content in a time of a day other than a busy time or using a predetermined number of or more contents within a predetermined time of a day (for example, using a content in a time of a day other than a defined busy time of 19:00˜21:00 or using 10 or more contents within 1 week) are described in value information has been shown in the above explanation, but the content using apparatus 103 may hold in advance these specific conditions or generate them based on some kind of rules.

As described above, the content distribution system 2 can realize a service of giving value information flexibly in various manners, such as giving value information to a user depending on his current content use such as content use in a time of a day other than a busy time, and on his past content use, and giving value information which is available only to a user who accumulates a predetermined amount of point information or the like, so as to exchange the value information with electronic value or a content.

(Third Embodiment)

The third embodiment of the present invention will be explained in detail below with reference to the drawings.

In the third embodiment of the present invention, a case of obtaining a content and value information from a package medium such as a DVD will be explained.

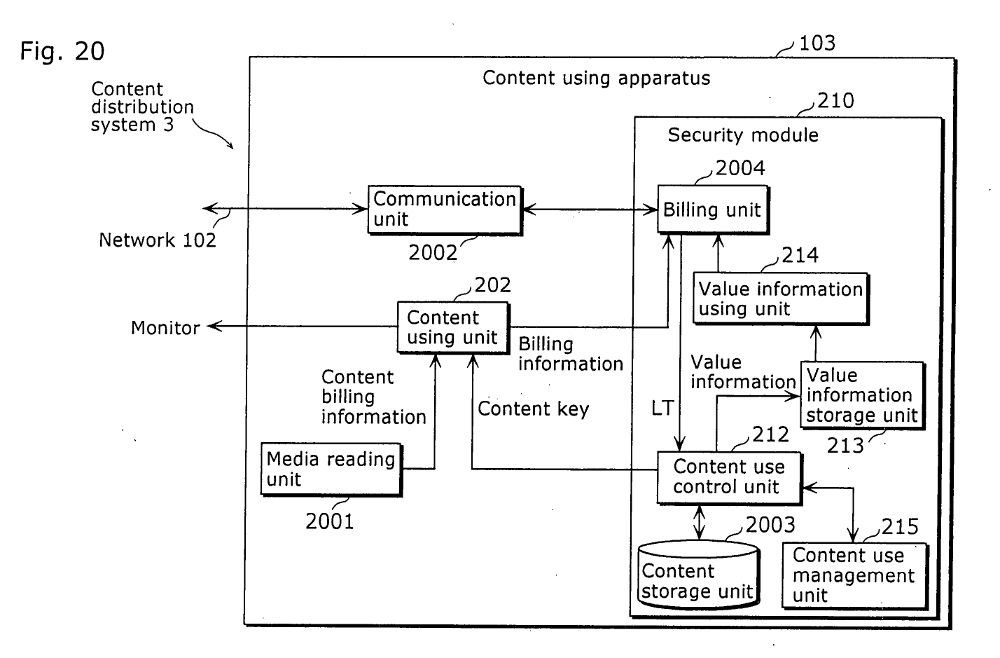

FIG. 20 is a block diagram showing a structure of a content using apparatus 103 according to the third embodiment of the present invention. In this figure, the same reference numbers as those in FIG. 2 are assigned to the same components as those in the content using apparatus 103 of the first embodiment in FIG. 2, and the explanation thereof is omitted. Also, the general view of the rough structure of the present content distribution system of the third embodiment is same as that of the content distribution system 1 as shown in FIG. 1, but will be explained assuming that it is the re-defined content distribution system 3.

The content using apparatus 103 in FIG. 20 includes a media reading unit 2001 for reading out data from a package medium such as a DVD, Instead of the broadcast receiving unit 201 in FIG. 2.

The content using apparatus 103 further includes a communication unit 2002 for communicating with the distribution center 101 via the network 102.

It also includes a content storage unit 2003 for storing contents in the security module 210. To be more specific, the content storage unit 2003 is a storage unit which is realized by a mass-storage flash memory or the like.

It is assumed that a billing unit 2004 included in the security module 210, which is different from the billing unit 211 for handling billing by means of electronic value as described in FIG. 2, is a billing unit having a credit card function. To be more specific, the billing unit 2004 holds credit card numbers and communicates with the billing server 101a in the distribution center 101 so as to perform billing processing online.

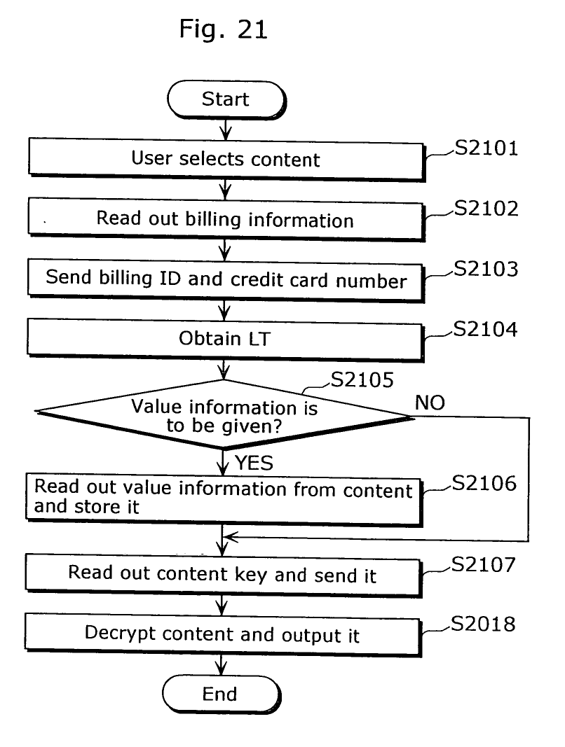

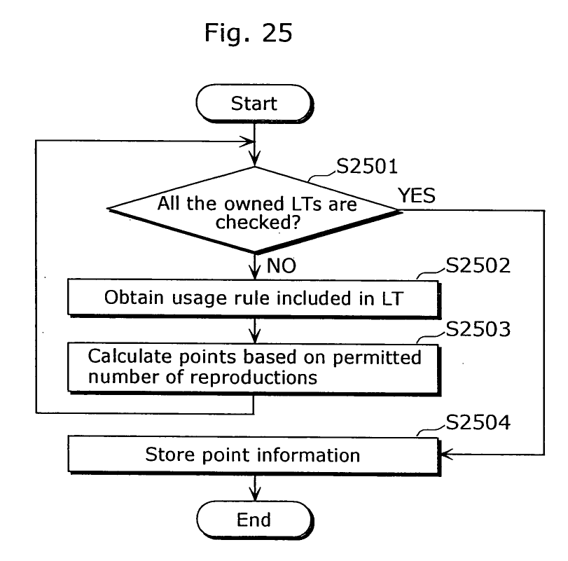

A sequence of operations conducted by the content using apparatus 103 structured as above of purchasing a content stored in a package medium, obtaining value information depending on content use, and using the value information will be explained with reference to flowcharts as shown in FIG. 21˜FIG. 25.

The following explanation will be made assuming that the value information in the present embodiment is embedded into a content by electronic watermarking.

First, operations of purchasing a content stored in a package medium and obtaining value information in the content using apparatus 103 will be explained with reference to a flowchart as shown in FIG. 21.

The content using apparatus 103 selects a content to be purchased using a user interface unit (not shown in FIG. 20) such as a browser for displaying a list of contents in a package medium (Step S2101).

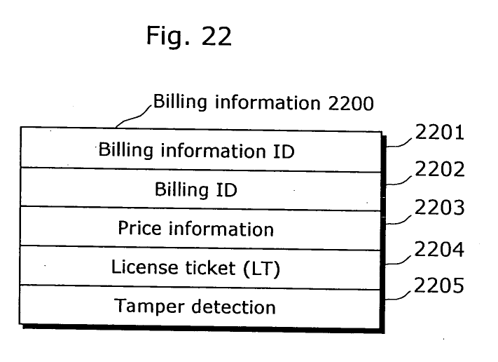

When a user selects the content, the media reading unit 2001 reads out billing information corresponding to the content (Step S2102). Here, the billing information is information as shown in FIG. 22, and is comprised of a billing information ID 2201, a billing ID 2202, price information 2203, a LT 2204 and a tamper detection 2205.

The billing information ID 2201 is a code for identifying a format or the like of the billing information 2200. The billing ID 2202 is an identifier used for billing. The billing unit sends the billing ID 2202 to the billing server 110a in the distribution center 101, where billing processing is performed.

The price information 2203 is information indicating the billed amount, namely, the price.

Since the LT 2204 and the tamper detection 2205 are same as the LT 404 and the tamper detection 405 in the ACI 304 as shown in FIG. 4, the explanation thereof is omitted here.

The billing unit 2004 carries out SAC communication with the billing server 101a in the distribution center 101 via the communication unit 2002 to perform billing processing (Step S2103). To be more specific, the billing unit 2004 sends at least the billing ID 2202 included in the billing information 2200 and the credit card number held in the billing unit 2004 to the billing server 110a where billing and settlement processing is performed.

Billing processing is not limited to the above-mentioned online billing processing, but the billing and settlement processing may be performed by storing the billing IDs 2202 in the billing unit 2004 and getting access to the billing server 101a on a regular basis to upload a plurality of billing IDs 2202 at a time.

After completing the billing processing, the billing unit 2004 obtains the LT 2204 included in the billing information 2200 and sends it to the content use control unit 212, while the content use control unit 212 receives the LT 2204 from the billing unit 211 (Step S2104).

The content use control unit 212 obtains electronic watermarked information added to the content, and checks whether value information is added to it or not. If the value information is added, the content use control unit 212 determines whether to give the value information to the user or not (Step 52105). Note that the processing of determining whether to give the value information or not will be explained later in detail.

In a case of YES in Step S2105, namely, when the value is given to the user, Step S2106 is executed.

In a case of NO in Step S2105, namely, when the value information is not given, Step S2107 is executed.

Note that if the value information is not added to the content, Step S2107 is executed.

The content use control unit 212 reads out from the content the value information embedded as an electronic watermark, and stores it in the value information storage unit 213 (Step S2106).

The content use control unit 212 reads out a content key from the LT 2204, and sends it to the content using unit 202 (Step S2107).

The content using unit 202 reads out the content from the media reading unit 2001, and decrypts the encrypted content with the content key received from the content use control unit 212 to reproduce the content (Step S2108).

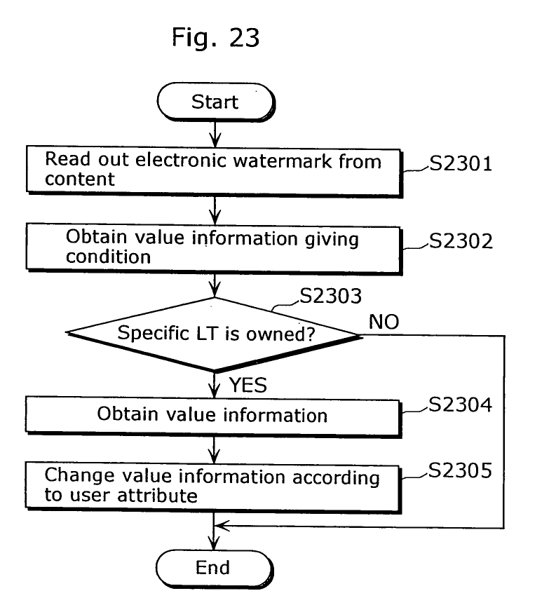

Next, the processing of determining whether to give the value information or not will be explained with reference to a flowchart in FIG. 23.

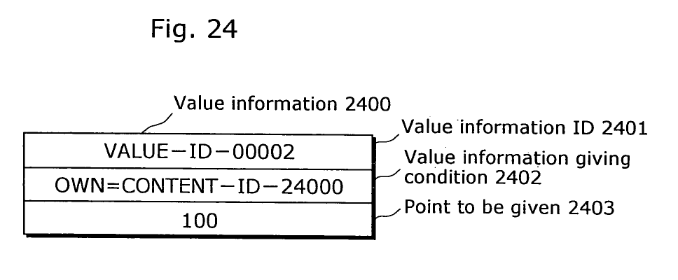

The content use control unit 212 detects the value information which is embedded in the content as electronic watermark information (Step S2301). Here, the value information embedded in the content as electronic watermark information is value information as shown in FIG. 24.

The content use control unit 212 obtains value information giving condition 2402 from the value information 2400 obtained in Step S2301 (Step S2302). In the value information giving condition 2402, the condition for giving value information, “OWN CONTENT-ID-24000” is described, which means that the content use management unit 215 owns a specific LT (a LT corresponding to the content with its content ID of “CONTENT-ID-24000”).

The content use control unit 212 searches whether or not the content use management unit 215 owns the LT corresponding to the content ID of “CONTENT-ID-24000” (Step S2303).

In a case of YES in Step S2303, namely, when the content use management unit 215 owns the LT, Step S2304 is executed. On the other hand, in a case of NO in Step S2303, namely, when the content use management unit 215 does not own the LT, the processing is ended.

The content use control unit 212 obtains information that is a basis of value information (Step S2304), and changes the value of the value information according to the user attribute held in the content use control unit 212 (Step S2305). To be more specific, the content use control unit 212 performs the processing of determining the value information to be given based on the user attribute held in the content use control unit 212, namely, the value information added as electronic watermark information according to the attributes of the services, such as a gold member and an ordinary member. For example, if the point information embedded in the content is “100 points”, the content use control unit 212 performs the processing of giving 100 points to the ordinary member and 200 points to the gold member with reference to the user attributes held in the content use control unit 212.

Whether the content use management unit 215 owns a specific LT or not is searched in Step S2303, and if it owns the specific LT, the value information is given. But the value information may be given if the content use management unit 215 owns a specific content stored in the content storage unit 2003 by searching for the specific content.

Also, in the present embodiment, the value information is given with the timing in conjunction with the user's action, but it may be given not according to the user's action. For example, the value information can be given when value information giving condition is satisfied as a result of checking whether the condition is satisfied or not at regular intervals, or as a result of checking whether the condition is satisfied or not with the timing when the status of the content use management unit 215 or the content storage unit 2003 is updated.

FIG. 25 is a flowchart showing a case where value information is given with such timing. This shows a case where all the LTs stored in the content use management unit 215 are checked and point information is given based on the permitted number of reproductions of its own LTs.

The content use control unit 212 confirms whether all the LTs stored in the content use management unit 215 are checked or not (Step S2501).

In a case of NO in Step S2501, namely, when all the LTs are not checked, Step S2502 is executed.

In a case of YES in Step S2501, namely, when all the LTs are checked, Step S2504 is executed.

The content use control unit 212 searches the action tag block of “reproduction” with reference to the action ID in the action tag block of the unchecked LT and obtains the permitted number of reproductions (number counter) (Step S2502).

The content use control unit 212 calculates the point information based on the obtained permitted number of reproductions (Step S2503). For example, the content use control unit 212 calculates the point information assuming that the permitted number of reproductions itself is the point information, or calculates the point information by multiplying the permitted number of reproductions by 10.

The content use control unit 212 calculates the total of the point information of all the LTs calculated in Step S2503, and updates the value of the point information in the value information storage unit 213 (Step S2504).

The case where the point information is given based on the number of reproductions of the owned LTs has been shown here, but the content using apparatus 103 or the security module 210 may hold this condition in advance, or it is possible to inquire the distribution center 101 about this condition to update it under a new condition.

In the present embodiment, the case where the billing unit 2004 having a credit card function performs online billing processing has been shown, but the billing and settlement processing may be performed by direct debit using a bank account by holding the bank account number in the billing unit 2004 and sending this account number to the billing server 101a with the timing of the billing processing. In this case, it is common to make the direct debit as a settlement on a fixed date every month (3rd of every month, for example). The billing unit 2004 does not always need to hold the bank account number but the user may input it. Also, the bank account number does not always need to be sent to the billing server 110a in the distribution center 101 for every billing processing, but it can also be sent with an arbitrary timing such as the initial use of this service.

Furthermore, the billing unit 2004 may be a means having not only bank account numbers but all the functions of a bank cash card. In other words, on every purchase of a content, the billing unit 2004 performs, via the billing server 101a, the processing of charging the fee of the content directly to the user's settlement account in which he makes deposits in advance.

In addition, in this billing processing, the billing server 101a may hold the upper limit of available amount of money in order not to accept the billing processing exceeding that limit. This upper limit can be set individually for each user, and thus a user himself may set it or a service provider may determine it.

In the manner as described above, a user purchases a content stored in a package medium or the like, and value information is given depending on or independently of the user's action under the content use control of the content use control unit 212, and stored in the value information storage unit 213.

(Fourth Embodiment)

The fourth embodiment of the present invention will be explained in detail with reference to the drawings.

In the fourth embodiment of the present invention, a case where a storage content is distributed by digital broadcasting, as with the case of the first embodiment of the present invention, will be explained. However, the storage content distributed in the present embodiment is a free content with an advertisement, to which an advertising content is added in addition to the content of the program main part. This advertising content may be distributed separately, of course. Here, it is assumed that the program content is a content on a travel program which is distributed in an unencrypted manner.

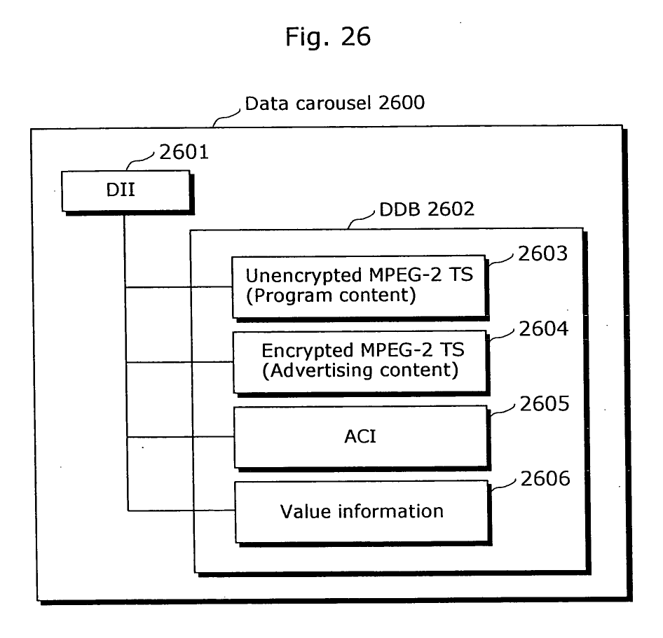

A content distributed by digital broadcasting in the present embodiment is a content according to a data carousel transmission system, as with the case of FIG. 3, and a file content as shown in FIG. 26.

Comparing the file content as shown in FIG. 26 with that in FIG. 3, the former is same as the latter in that the data carousel 2600 is comprised of a DII 2601 and a DDB 2602, but different in that a file to be distributed is comprised of a program content 2603 distributed by an unencrypted MPEG-2 TS, an advertising content 2604 distributed by an encrypted MPEG-2 TS, ACI 2605 storing access information on the advertising content 2604, and value information 2606 which is given to a user when he uses the advertising content 2604. A content key for the advertising content 2604 is set in the ACI 2605, and a signature which can be authenticated by the content use control unit 212 is added to the value information 2606 due to a tampering risk. As this signature, an EC-DSA (Elliptic Curve-Digital Signature Algorithm) signature or the like can be used.

In a content based on such a data carousel 2600 system, since the program content 2603 that is the main body of the program is a free program distributed in an unencrypted manner, a user can use it any number of times as much as he likes. On the other hand, since the advertising content 2604 is free but distributed in an encrypted manner, the advertising content 2604 needs to be decrypted with a content key for use by obtaining the corresponding LT with reference to the ACI 2605 and further obtaining the content key. At this time, the corresponding LT can be obtained without the billing processing by the billing unit 211 because advertisements are usually free of charge. The value information can be obtained if the advertisement is viewed or listened to using this LT and a certain condition is satisfied.

Also, the structure of the ACI 2605 is same as that of the ACI 304 as shown in FIG. 4, but the fee 403 is described as “0 yen” because of a free program.

Obtaining of value information again and again can be allowed in some cases but cannot be allowed in other cases. In other words, some advertising contents allow repeated views of the contents and obtaining of a plurality of the value information thereof, and other advertising contents do not allow them, depending upon a type of services, so it is desirable to realize flexible specification of these services.

Therefore, if obtaining of a plurality of value information is not allowed, the following methods can be conceived, for example: an ID for identifying the ACI 2605 uniquely (the ID may be assigned so as to be unique in the content using apparatus 103) is recorded and the LT is not given if the user tries to use the same ACI 2605 again; and the LT usage history table 1800 as shown in FIG. 18 is put under the management of the content use control unit 212 and the value information is not given if the user tries to use the LT again.

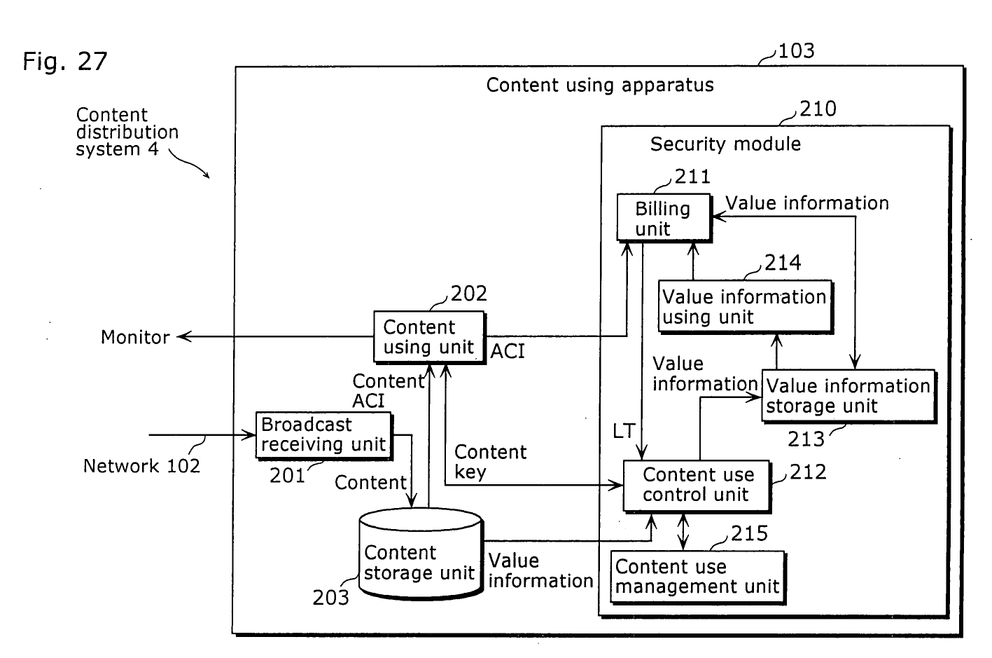

FIG. 27 is a block diagram showing the structure of the content using apparatus 103 according to the fourth embodiment of the present invention. In this figure, the same reference numbers as those in FIG. 2 are assigned to the same components as those in the content using apparatus 103 of the first embodiment in FIG. 2, and the explanation thereof is omitted. Also, the general view of the rough structure of the present content distribution system of the fourth embodiment is same as that of the content distribution system 1 as shown in FIG. 1, but will be explained assuming that it is the re-defined content distribution system 4.

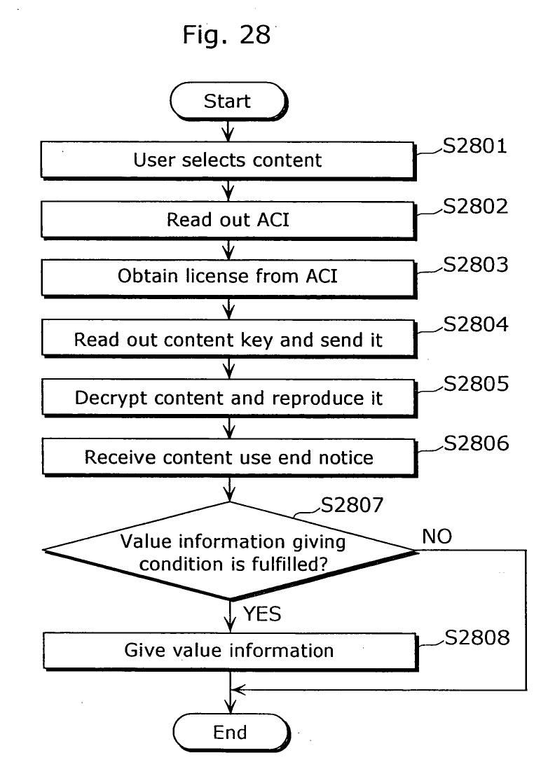

Operations conducted in this content using apparatus 103 of storing contents obtained from digital broadcasting in the content storage unit 203 and a user's purchasing and using the stored contents and obtaining the value information depending on his content use will be explained with reference to the flowchart as shown in FIG. 28. Since the operation of storing an input stream obtained from digital broadcasting in the content storage unit 203 is same as that in the flowchart of FIG. 10 in the first embodiment of the present invention, the explanation thereof will be omitted here.

A user selects an advertising content 2604 attached to a program content 2603 from a list of contents stored in the content storage unit 203 using a user interface unit not shown in FIG. 27 (Step S2801).

The content using unit 202 searches the content storage unit 203 for the advertising content 2604 selected by the user, and obtains the ACI 2605 corresponding to the advertising content 2604 (Step S2802). To be more specific, when the user selects the advertising content 2604, the ACI 2605 relevant to the selected content is read out from the content storage unit 203. Here, as a method for obtaining the relevant ACI 2605, a method for attaching a content header with the URI of the ACI 2605 described therein to the content, or setting a descriptor with the URI of the ACI 2605 described therein for the DII 2601 may be used.

The billing unit 211 obtains the LT of the advertising content 2604 from the ACI 2605, and sends it to the content use control unit 212 (Step 52803). To be more specific, since the program content 2603 is a free content, the billing unit 211 does not perform the billing processing (or performs the billing processing assuming the fee is 0 yen) if recognizing that the fee set for the ACI 2605 is 0 yen, but obtains the LT of the advertising content 2604 and passes it to the content use control unit 212.

The content use control unit 212 obtains the content key from the LT, and sends it to the content using unit 202 (Step S2804).

The content using unit 202 decrypts the encrypted advertising content 2604 with the content key received from the content use control unit 212, and reproduces the advertising content 2604 (Step S2805). After the use of the advertising content 2604 ends, the content using unit 202 sends a content use end notice to the content use control unit 212.

The content use control unit 212 receives the content use end notice from the content using unit 202 (Step S2806).

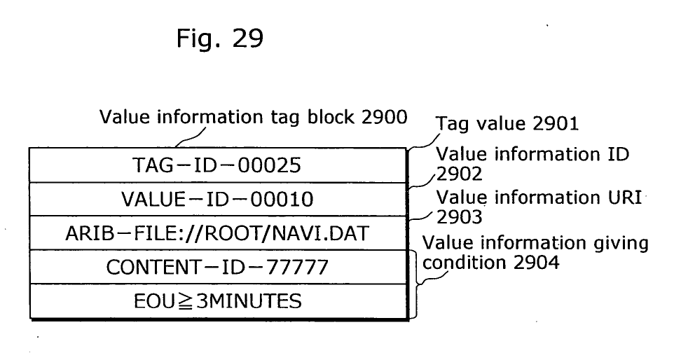

The content use control unit 212 judges based on the time of receiving the content use end notice whether the advertising content 2604 has been used to the end or not so as to determine whether to give value information to the user or not (Step S2807). To be more specific, the content use control unit 212 measures a period of time by a counter or the like from passing the content key to the content using unit 202 until its receipt of the content use end notice. For example, since “CONTENT-ID-77777” and “EOU >=3MINUTES” are described as a value information giving condition 2904 in a value information tag block 2900 of the LT, as shown in FIG. 29, the content use control unit 212 judges that the condition for giving the value information is satisfied if the advertising content 2604 (whose content ID is assumed to be “CONTENT-ID-77777”) has been used and 3 minutes or longer have passed before EOU (End of Use), namely, receiving the content use end notice.

In a case of YES in Step S2807, namely, when the value information giving condition is satisfied, Step S2808 is executed.

In a case of NO in Step S2807, namely, when the value information giving condition is not satisfied the value information is not given to the user but the content using processing is ended.

The content use control unit 212 gives the obtained value information to the user (Step S2808). Here, the URI of the value information of “ARIB-FILE://ROOT/NAVI.DAT” is set for a value information URI 2903 in the value information tag block 2900 as shown in FIG. 29, and thus the value information can be structured as a separate file from the content or the LT. The content use control unit 212 can obtain the value information 2606 based on the URI described in the value information URI 2903. The content use control unit 212 reads out the value information from the content storage unit 203 based on this value information URI 2903, and stores it in the value information storage unit 213. To be more specific, the content use control unit 212 reads out the value information 2606 from the content storage unit 203 based on the value information URI 2903, verifies the digital signature attached to the value information 2606 to judge whether it is authorized value information or not, and stores it in the value information storage unit 213 only if it is the authorized value information. Note that if it fails to verify the digital signature attached to the value information 2606, it ends the present processing.

A case where the value information 2606 is encrypted may be considered. In this case, the value information 2606 may be encrypted in advance with a key held by the content use control unit 212, or a cipher key for decrypting the value information can be set in the value information tag block 504.

Also, the present embodiment shows an example where the value information URI 2903 in the value information tag block 2900 specifies the URI of the value information in the data carousel. But the present invention is not limited to this, but it is also possible to specify information which can be represented by an URI such as a typical URI on the Internet and thus download the value information from the specified URI.

The value information is stored in the value information storage unit 213 based on the use of the advertising content in the manner as mentioned above. The value information is, in this case, information related to the program content and the advertising content. For example, since the present program content is a travel program, the value information for that content is data of a car navigation system for a destination introduced in the program, a discount coupon of a store located on the route to the destination, or the like. The data for the car navigation system stored in the security module 210 can be used by detaching the security module 210 from the content using apparatus 103 and inserting it into a car navigation terminal in a car, or contents or other products can be purchased based on the sequence for using the value information as shown in FIG. 12 of the first embodiment by carrying the security module 210 to the store located on the route to the destination.

(Fifth Embodiment)

The fifth embodiment of the present invention will be explained in detail with reference to the drawings.

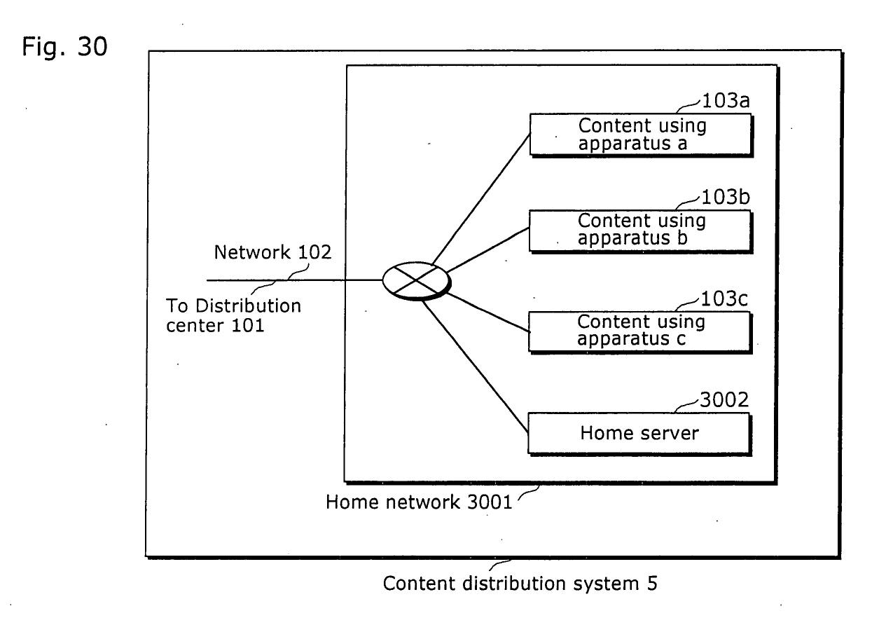

FIG. 30 is a general view of a rough structure of a content distribution system 5 according to the fifth embodiment of the present invention. Since the structure of this content distribution system 5 is same as that of the content distribution system 1 in FIG. 1, the distribution center 101 is omitted in this figure. In the content distribution system 5, the network 102 connected with the distribution center 101 is realized by IEEE802.3 (10/100 Base-T), a wireless LAN or the like, via a gateway not shown in this figure, and connected with a home network 3001 for making communication by a protocol such as TCP/IP. In addition to the content using apparatus 103a˜103c, a home server 3002 is connected to the home network 3001.

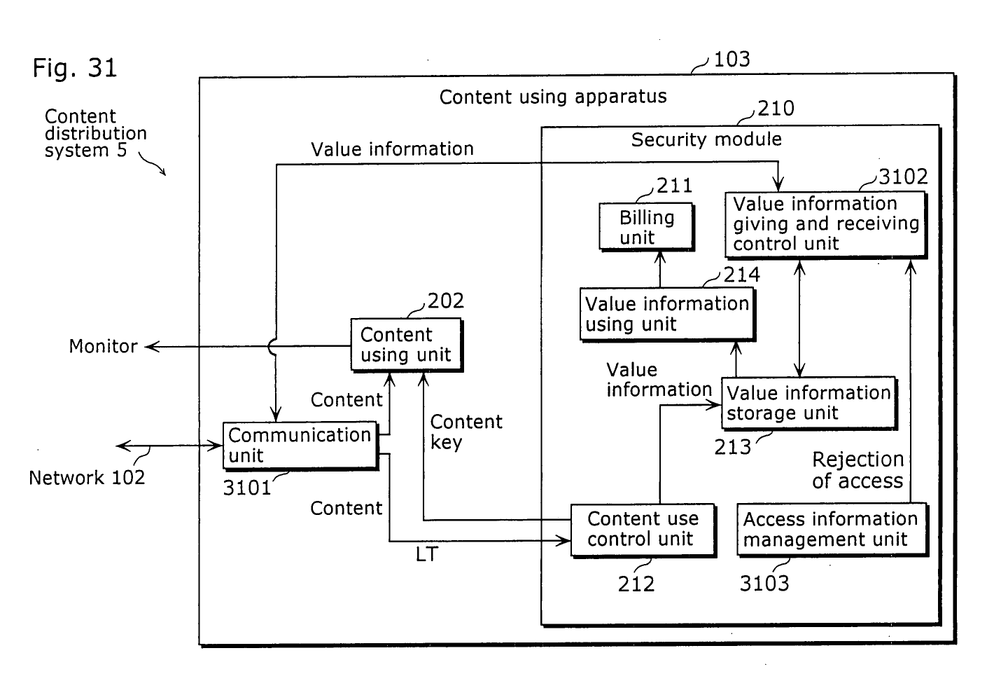

FIG. 31 is a block diagram showing a structure of a content using apparatus 103 according to the fifth embodiment of the present invention. Since the structure of the home server 3002 is basically same as the content using apparatus 103, the content using apparatus 103 is shown in this figure as a representative structure. The same reference numbers are assigned to the same components as those in the content using apparatus 103 of the first embodiment in FIG. 2, and the explanation thereof will be omitted.

The content using apparatus in FIG. 31 includes a communication unit 3101 for communicating with other content using apparatuses 103 via the home network 3001, instead of the broadcast receiving unit 201 in FIG. 2.

Also, in addition to the content using apparatus 103 in FIG. 2, the content using apparatus 103 in this embodiment includes a value information giving and receiving control unit 3102 for giving and receiving value information with other content using apparatuses 103 and an access information management unit 3103 for managing access information indicating accessibility between a plurality of content using apparatuses 103. The content storage unit 203 in FIG. 2 is omitted.

The value information giving and receiving control unit 3102 determines based on the access information obtained from the access information management unit 3103 whether or not to give or receive the value information stored in the value information storage unit 213.

The access information management unit 3103 manages information that is identification information for establishing a kind of domain between the content using apparatuses 103, such as an ID which is uniquely assigned to the security module 210 (a security module ID) and a user ID. Specific examples of such information managed by the access information management unit 3103 will be explained in detail later with reference to the figures.

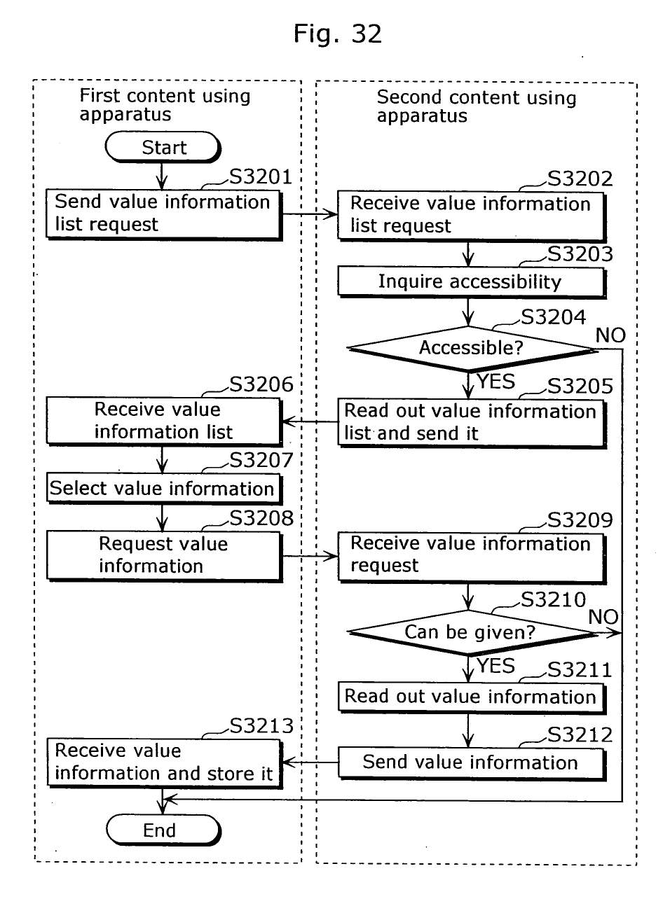

Operations of giving and receiving value information between the content using apparatus 103 structured as mentioned above (a first content using apparatus) and another content using apparatus 103 (a second content using apparatus) will be explained with reference to the flowchart in FIG. 32. A sequence of operations of purchasing and using contents will be omitted here because it is same as that in the first˜fourth embodiments of the present invention.

When a user who uses the first content using apparatus 103 wants to obtain value information held in the second content using apparatus 103, the first content using apparatus 103 sends a value information list request to the second content using apparatus 103 (Step S3201). To be more specific, according to the user's instruction, the value information giving and receiving control unit 3102 of the first content using apparatus 103 sends the value information list request to the second content using apparatus 103 via the communication unit 3101. A security module ID that the value information giving and receiving control unit 3102 of the first content using apparatus 103 has obtained from the access information management unit 3103 thereof is assigned to this value information list request.

The second content using apparatus 103 receives the value information list request from the first content using apparatus 103 (Step S3202). To be more specific, the communication unit 3101 of the second content using apparatus 103 receives the value information list request from the communication unit 3101 of the first content using apparatus 103, and passes it to the value information giving and receiving control unit 3102 of the second content using apparatus 103.

The value information giving and receiving control unit 3102 inquires of the access information management unit 3103 about the accessibility (Step S3203). To be more specific, the value information giving and receiving control unit 3102 of the second content using apparatus 103 sends the security module ID of the first content using apparatus 103 included in the value information list request to the access information management unit 3103.

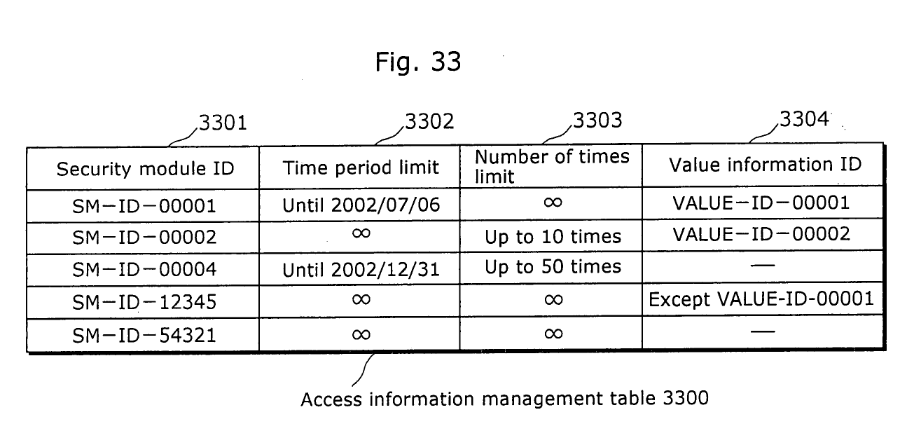

The access information management unit 3103 of the second content using apparatus 103 judges whether or not to accept access from the received security module ID of the first content using apparatus 103 (Step S3204). To be more specific, the access information management unit 3103 of the second content using apparatus 103 holds an access information management table used for controlling the access from the content using apparatus 103 that has accessed, and judges the accessibility of the content using apparatus 103 using this access information management table. FIG. 33 is an example of the access information management table, and this access information management table is held in each content using apparatus 103.

The access information management table 3300 includes a security module ID 3301 on the accessing side, a time period limit on access (an access time limit) 3302 and a number of times limit on access 3303. For example, this access information management table 3300 shows that the content using apparatus 103 with its “security module ID=SM-ID-00001” has access until 2002/07/06 unlimited number of times (co), the content using apparatus 103 with its “security module ID=SM-ID-00002” has access up to 10 times with no limit of access time period (∞). Furthermore, the content using apparatus 103 with its “security module ID=SM-ID-12345” has access with no limit of time period nor number of times. The content using apparatus 103 which is not registered in the access information management table 3300 cannot access.

In a case of YES in Step S3204, namely, when it is judged that the first content using apparatus 103 can access, Step S3205 is executed.

In a case of NO in Step S3204, namely, when it is judged that the first content using apparatus 103 cannot access, the value information giving and receiving processing is ended and the end of the processing is sent to the first content using apparatus 103.

The value information giving and receiving control unit 3102 of the second content using apparatus 103 obtains the value information list including IDs for identifying value information (value information IDs) as shown in FIG. 8 from the value information storage unit 213 of the second content using apparatus 103, and sends the value information list to the first content using apparatus 103 (Step S3205).

The communication unit 3101 of the first content using apparatus 103 receives the value information list from the communication unit 3101 of the second content using apparatus 103, and passes it to the value information giving and receiving control unit 3102 of the first content using apparatus 103 (Step 53206).

The first content using apparatus 103 offers the value information list to the user using a user interface unit not shown in the figure, and thus the user selects the value information he would like to obtain from the second content using apparatus 103 (Step S3207).

The value information giving and receiving control unit 3102 of the first content using apparatus 103 requests the value information inputted by the user from the second content using apparatus 103 (Step S3208). To be more specific, when the user selects the value information he would like to obtain from the second content using apparatus 103, the value information giving and receiving control unit 3102 of the first content using apparatus 103 sends the value information ID for identifying the value information to the second content using apparatus 103.

The communication unit 3101 of the second content using apparatus 103 receives the value information ID from the first content using apparatus 103, and passes it to the value information giving and receiving control unit 3102 (Step S3209).

The value information giving and receiving control unit 3102 of the second content using apparatus 103 judges whether the value information identified with that value information ID can be given or not (Step S3210). To be more specific, the value information giving and receiving control unit 3102 of the second content using apparatus 103 holds in itself, on every type of value information, the access information management table 3300 that is a table for judging whether value information can be given to other content using apparatuses 103 or not, so it judges whether the value information identified with the received value information ID can be given or not, using this access information management table 3300. For example, the access information management table 3300 shows that the content using apparatus 103 having a security module ID of “SM-ID-00001” can give or receive only the value information with its value information ID “VALUE-ID-00001”, and the content using apparatus 103 having a security module ID of “SM-ID-00002” can give or receive only the value information with its value information ID “VALUE-ID-00002”. Furthermore, the content using apparatus 103 having a security module ID of “SM-ID-12345” can give or receive any value information except the value information with its value information ID “VALUE-ID-00001”. Also, the value information ID “-” indicates that there is no limit to the types of value information in giving and receiving it.

In a case of YES in Step S3210, namely, when the value information can be given, Step S3211 is executed.

In a case of NO in Step S3210, namely, when the value information cannot be given, value information giving and receiving processing is ended and the end of the processing is sent to the first content using apparatus 103.

The value information giving and receiving control unit 3102 of the second content using apparatus 103 reads out, from the value information storage unit 213 of the second content using apparatus 103, the value information corresponding to the value information ID requested by the first content using apparatus 103 (Step S3211), and sends it to the first content using apparatus 103 (Step S3212).

The first content using apparatus 103 receives the value information from the second content using apparatus 103, and the giving and receiving of the value information is completed (Step S3213). To be more specific, the communication unit 3101 of the first content using apparatus 103 receives the value information sent from the second content using apparatus 103, and passes it to the value information giving and receiving control unit 3102 of the first content using apparatus 103. The value information giving and receiving control unit 3102 of the first content using apparatus 103 stores the received value information in the value information storage unit 213 of the first content using apparatus 103, and completes a series of the processing. Note that accessibility is judged when value information list is requested in FIG. 32, but access may be controlled when value information is actually obtained, not controlling accessibility when value information list is requested.

As described above, giving and receiving of value information can be controlled based on access information held by each content using apparatus or a type of value information.

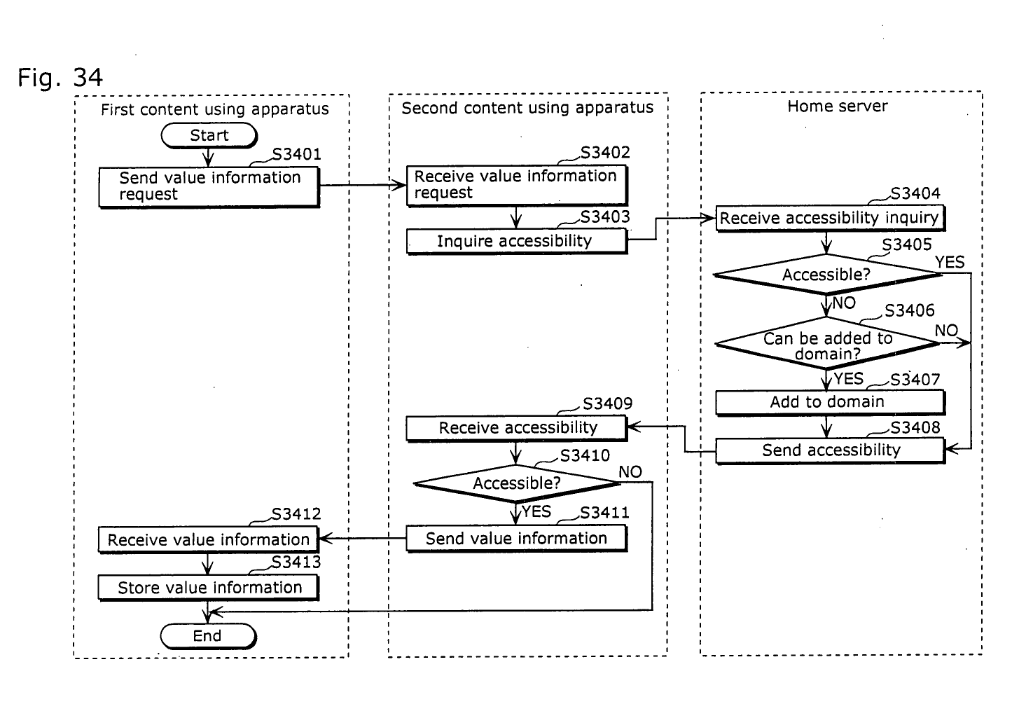

By the way, each content using apparatus holds the access information management table 3300 so as to judge accessibility in FIG. 32, but the home server 3002 may judge accessibility in a centralized manner. In this case, each of the content using apparatuses 103 other than the home server 3002 does not need to hold the access information management table 3300 for managing access information, but only the home server 3002 needs to hold it. Operations of giving and receiving value information conducted in this case will be explained with reference to the flowchart in FIG. 34. Since a sequence of operations of obtaining value information list in FIG. 34 is same as that in FIG. 32, it will be omitted here, and a sequence of operations conducted after a value information ID that a user would like to obtain from another content using apparatus 103 is determined will be explained below.

The first content using apparatus 103 sends a value information request to the second content using apparatus 103 (Step S3401). It is assumed that this value information request includes security module IDs of the content using apparatuses 103.

The second content using apparatus 103 receives the value information request from the first content using apparatus 103 (Step S3402).

The second content using unit 103 inquires of the home server 3002 about accessibility in order to judge whether the access from the first content using apparatus 103 is authorized or not (Step S3403). To be more specific, the value information giving and receiving control unit 3102 of the second content using apparatus 103 inquires of the home server 3002 about the accessibility based on the security module ID of the first content using apparatus 103 as an accessing side and the security module ID of the second content using apparatus 103 as an accessed side.

The home server 3002 receives the access inquiry from the second content using apparatus 103 (Step S3404).

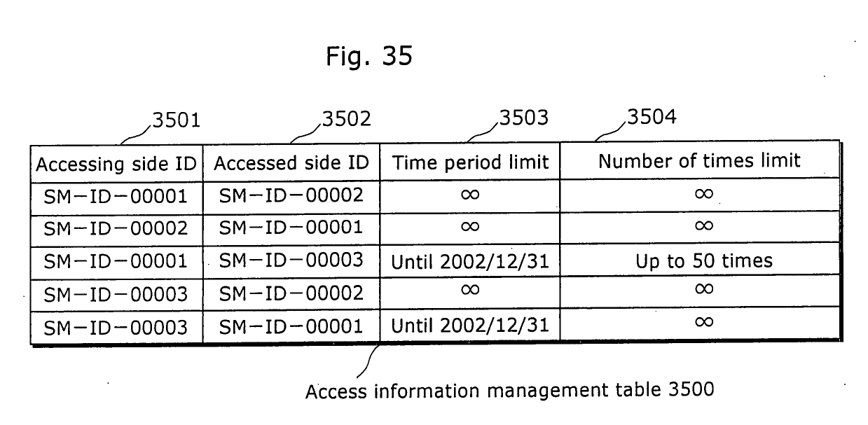

The value information giving and receiving control unit 3102 of the home server 3002 sends the security module IDs to the access information management unit 3103 of the home server 3002 to judge accessibility (Step S3405). To be more specific, the access information management unit 3103 holds an access information management table 3500 as shown in FIG. 35, and controls the access of the content using apparatuses 103 using the access information management table 3500.

The access information management table 3500 includes an accessing side ID 3501 indicating a security module ID of an accessing side, an accessed side ID 3502 indicating a security module ID of an accessed side, a time period limit on access (an access time limit) 3503 and a number of times limit on access 3504. For example, this access information management table 3300 shows that the content using apparatus 103 with its “security module ID=SM-ID-00001” can access the content using apparatus 103 with its “security module ID=SM-ID-00002” with no limit of time period nor number of times (co), and the content using apparatus 103 with its “security module ID=SM-ID-00001” can access the content using apparatus 103 with its “security module ID=SM-ID-00003” until 2002/12/31 and up to 50 times. The content using apparatuses 103 cannot access to each other if their accessing side ID 3501 and accessed side ID 3502 are not registered in the access information management table 3500 respectively.

Therefore, the value information giving and receiving control unit 3102 of the home server 3002 searches for the record in which the accessing side ID 3501 is the security module ID of the first content using apparatus 103 and the accessed side ID 3502 is the security module ID of the second content using apparatus, with reference to the access information management table 3500, and performs the processing so as to be inaccessible when there is no such a record and to be accessible when there is such a record.

In a case of NO in Step S3405, namely, when it is inaccessible, Step S3406 is executed.

In a case of YES in Step S3405, namely, when it is accessible, Step S3408 is executed.

In Step S3406, it is judged whether or not to add the content using apparatus 103 which is not registered in the access information management table 3500 to the domain (to authorize the content apparatus 103 to access) (Step S3406). To be more specific, the access information management unit 3103 of the home server 3002 manages the maximum number of records or security module IDs which can be registered in the access information management table 3500, and adds a new record to the access information management table 3500 if a new content using apparatus 103 can be added to the domain.

A security module ID of a new content using apparatus 103 may be added to the access information management table 3500 automatically and unconditionally. Also, when the security module ID of the new content using apparatus 103 is added to the access information management table 3500, the billing unit 211 of the home server 3002 may handle the billing. Or, it may charge a new content using apparatus 103 added after a predetermined number of content using apparatuses 103 have been added to the domain, although a new content using apparatus 103 can be added to the domain at no charge before the predetermined number of them have been added.

In a case of YES in Step S3406, namely, when the content using apparatus 103 can be added to the domain, Step S3407 is executed.

In a case of NO in Step S3406, namely, when the content using apparatus 103 cannot be added to the domain, Step S3408 is executed.

The access information management unit 3103 of the home server 3002 adds the security module ID of the accessing side and the security module ID of the accessed side to the access information management table 3500 of the home server 3002 (Step S3407).

The access information management unit 3103 of the home server 3002 sends the accessibility to the second content using apparatus 103 (Step S3408). To be more specific, the access information management unit 3103 of the home server 3002 sends “accessible” to the second content using apparatus 103 when it is judged to be accessible in Step 53405 or a new content using apparatus 103 is added to the domain in Step S3407, while it sends “inaccessible” to the second content using apparatus 103 when the new content using apparatus 103 cannot be added to the domain.

The communication unit 3101 of the second content using apparatus 103 receives the accessibility from the homer server 3002, and sends it to the value information giving and receiving control unit 3102 of the second content using apparatus 103 (Step S3409).

The value information giving and receiving control unit 3102 of the second content using apparatus 103 determines whether or not to send value information to the first content using apparatus 103 based on the accessibility sent from the home server 3002 (Step S3410).

In a case of YES in Step S3410, namely, when receiving “accessibility” from the home server 3002, the second content using apparatus 103 executes Step S3411.

In a case of NO in Step S3410, namely, when receiving “inaccessibility” from the home server 3002, the second content using apparatus 103 ends the present processing and sends the end of the processing to the first content using apparatus 103.

The value information giving and receiving control unit 3102 of the second content using apparatus 103 obtains, from the value information storage unit 213 thereof, the value information corresponding to the value information ID requested by the first content using apparatus 103, using the value information request, and sends it to the first content using apparatus 103 (Step S3411).

The communication unit 3101 of the first content using apparatus 103 receives the value information from the second content using apparatus 103, and sends it to the value information giving and receiving control unit 3102 of the first content using apparatus 103 (Step S3412).

The value information giving and receiving control unit 3102 of the first content using apparatus 103 stores the received value information in the value information storage unit 213 of the first content using apparatus 103 (Step S3413). At this time, the billing unit 211 of the first content using apparatus may perform the billing processing for the giving and receiving of the value information. For example, it may collect a definite amount of money on every receipt of value information, or it may charge a variety of amounts depending on the value information.

As mentioned above, the present invention can be structured so that the home server 3002 controls giving and receiving value information in a centralized manner based on establishment of a domain using access information.

As described above, in the fifth embodiment, a content using apparatus 103 can give and receive value information to and from other content using apparatuses 103, so a user can give a discount ticket or the like to his friend as a gift. The value information which has been given and received between the content using apparatuses 103 can be used for purchasing contents via a network or on a service terminal, as explained in the first fourth embodiments of the present invention.

As an application of the present embodiment, a single content using apparatus 103 can add together value information held by a plurality of content using apparatuses 103 separately. For example, if value information is point information, user convenience may be extremely lowered if point information stored in a plurality of content using apparatuses 103 in a home network 3001 separately cannot be added together. According to the present invention, the home server 3002 or one content using apparatus 103 in the home network 3001 can add together the point information obtained from other content using apparatuses 103 as responses to its sequential requests for their point information, and thus a system with high user convenience can be configured.

In the present embodiment, access is controlled using security module IDs held in the access information management unit 3103 in the security module 210, but it may be conceived to control giving and receiving of value information by combining the above-mentioned security module IDs and information such as terminal IDs which are recorded in a security-ensured area other than the area realized by the security module 210 in the content using apparatus 103. By doing so, it is possible to control giving and receiving of value information based on the association between the content using apparatus 103 itself and the security module 210.

Also, when a content using apparatus 103 exchanges different types of value information with other content using apparatuses 103, it is possible to make the billing unit 211 of the security module 210 control the exchange rates of these different types of value information.

In the present embodiment, an example where value information is given and received between the content using apparatuses 103 in the home network 3001 has been explained, but value information can be given and received, via the network 102, with the content using apparatuses 103 which belong to other home networks 3001 in the same manner.

In the present embodiment, an example where value information is exchanged between the first content using apparatus 103 and the second content using apparatus 103 has been explained, but LTs and contents may be exchanged in the same manner.

Furthermore, for exchanging an LT, the LT may be divided so as to give a user value information depending on the divided portion thereof. Here, the LT division means processing of generating a LT with its reproduction number counter of “7” and a LT with its reproduction number counter of “3” in order to give a friend only the LT for “3” times out of the original LT for total “10” times of reproductions described in the action tag block of the LT.

In the first˜fifth embodiments of the present invention, value information may be given depending on information inputted by a user. For example, an easy quiz or questionnaire on a program is sent to users and value information is given to them if they answer the quiz correctly or answer the questionnaire, and thus users' easy obtainment of value information can be prevented.

In the first˜fifth embodiments of the present invention, value information may be given to users depending on the capability or the type of the content using apparatus 103 or the security module 210. In this case, the content using apparatus 103 or the security module 210 includes a unit for holding information indicating its capability and type, and thus the content use control unit 212 performs the processing of giving value information based on the information indicating the capability and the type thereof.

Also, in the first-fifth embodiments of the present invention, it is possible to include a mechanism for proving that value information has been given to a user securely. To be more specific, by storing the value information together with the secure time in the value information storage unit 213 using the clock 1302 as shown in FIG. 13, the value information can be used as information for proving when the user obtained what kind of value information. Or, by communicating with the distribution center 101 at the appropriate times, the distribution center 101 may record the giving of the value information.

Furthermore, in the first-fifth embodiments of the present invention, an example where a content, a license, value information and the like are captured via a single distribution channel has been explained, but they may be captured via multiple distribution channels such as digital broadcasting and the Internet or a package medium and the Internet.

### INDUSTRIAL APPLICABILITY

The billing server, the right management server, the distribution server, the value information distribution server and the Web server according to the present invention are useful as servers located in a content distribution center on the Internet, a digital broadcast station or the like.

Also, the content using apparatus according to the present invention is useful as a personal computer with a communication function, a PDA, an STB for receiving digital broadcasts, a digital television, a mobile phone or the like.

1. A content using apparatus for providing content use to a user under a license that grants the content use, comprising:
a value information storage unit operable to obtain and store value information indicating a benefit for the user;
a condition judgment unit operable to judge, depending on the content use, whether a condition for allowing the user to use the value information is satisfied or not; and
a value information using unit operable to allow the user to use the value information when the condition is satisfied as a result of the judgment.

2. The content using apparatus according to claim 1,
wherein the condition judgment unit obtains the condition corresponding to the value information from outside and judges whether the obtained condition is satisfied or not.

3. The content using apparatus according to claim 1,
wherein the condition judgment unit holds a predetermined value of the condition in advance and judges whether the held condition is satisfied or not.

4. The content using apparatus according to claim 3, further comprising a condition obtainment unit operable to obtain a new value of the condition and update the held condition,
wherein the condition judgment unit judges whether the updated condition is satisfied or not.

5. The content using apparatus according to claim 1,
wherein the condition judgment unit generates the condition according to a predetermined rule and judges whether the generated condition is satisfied or not.

6. The content using apparatus according to claim 1, further comprising a billing unit operable to settle a use fee depending on the content use,
wherein the value information indicates a right to appropriate a predetermined amount of money for the settlement of the use fee by the billing unit, and
the value information using unit makes the appropriation when the condition is satisfied.

7. The content using apparatus according to claim 6,
wherein the billing unit makes the settlement of the use fee by accumulating electronic value and subtracting an amount of the use fee from a balance of the accumulated electronic value.

8. The content using apparatus according to claim 1,
wherein the value information indicates a right to exchange the value information with any one of electronic value, a premium content, a discount coupon, a concert ticket, an admission ticket and an accommodation coupon.

9. The content using apparatus according to claim 1,
wherein the condition is to obtain a predetermined number of the value information.

10. The content using apparatus according to claim 1,
wherein the condition indicates an expiration date for allowing an effective use of the value information.

11. The content using apparatus according to claim 1,
wherein at least one of the value information storage unit, the condition judgment unit and the value information using unit is realized by a tamper-resistant security module.

12. The content using apparatus according to claim 1, further comprising:
a communication unit operable to access another content using apparatus, and give and receive the value information to and from said another content using apparatus; and
a giving and receiving limitation unit operable to limit the giving and receiving of the value information,
wherein the communication unit gives and receives the value information to and from said another content using apparatus under the limitation.

13. The content using apparatus according to claim 12, further comprising a billing unit operable to settle a fee depending on the giving and receiving of the value information,
wherein the billing unit settles the fee for the giving and receiving when the value information is given and received to and from said another content using apparatus.

14. The content using apparatus according to claim 13,
wherein at least one of the value information storage unit, the condition obtainment unit, the condition judgment unit, the value information using unit, the billing unit and the giving and receiving limitation unit is realized by a tamper-resistant security module.

15. The content using apparatus according to claim 12, further comprising an access information management unit operable to manage an access information management table that describes information on accessibility to said another content using apparatus,
wherein the giving and receiving limitation unit limits the giving and receiving of the value information to and from said another content using apparatus based on the access information management table.

16. The content using apparatus according to claim 15,
wherein the access information management unit checks whether or not said another content using apparatus that requests access to the communication unit is registered in the access information management table, and registers said another content using apparatus that requests the access additionally in the access information management table if said another content using apparatus is not registered.

17. The content using apparatus according to claim 16, further comprising a billing unit operable to settle a fee for the registration of said another content using apparatus,
wherein the billing unit settles the fee for the additional registration of said another content using apparatus when said another content using apparatus is registered additionally in the access information management table.

18. The content using apparatus according to claim 12,
wherein the giving and receiving limitation unit limits the giving and receiving of the value information to and from said another content using apparatus depending on a type of the value information.

19. The content using apparatus according to claim 1,
wherein the value information storage unit obtains the value information when the user uses one or more specific contents.

20. The content using apparatus according to claim 19,
wherein said one or more specific contents are one or more advertisements, and
the value information storage unit obtains the value information when the user views or listens to said one or more advertisements.

21. The content using apparatus according to claim 19,
wherein said one or more specific contents are one or more questionnaires, and
the value information storage unit obtains the value information when the user answers said one or more questionnaires.

22. The content using apparatus according to claim 1, further comprising a history management unit operable to manage a history of the content use or a history of license use for the content,
wherein the value information storage unit obtains the value information when it is judged, based on the history managed by the history management unit, that one or more specific contents or one or more licenses for said specific contents are all used.

23. The content using apparatus according to claim 22,
wherein the value information storage unit obtains the value information when it is judged, based on the history managed by the history management unit and dates and times when said contents or said licenses for the contents are used, that a predetermined or larger number of the contents or the licenses are used within a predetermined period of time.

24. The content using apparatus according to claim 1, further comprising a content storage unit operable to obtain and store contents,
wherein the value information storage unit obtains the value information when one or more specific contents are stored in the content storage unit.

25. The content using apparatus according to claim 1,
wherein the value information storage unit obtains the value information depending on a time period of a day during which the content is used.

26. The content using apparatus according to claim 1, further comprising a license storage unit operable to obtain and store a license for a content according to an operation of the user,
wherein the value information storage unit obtains the value information depending on an amount of the content use granted under the license stored in the license storage unit.

27. The content using apparatus according to claim 1, further comprising a license storage unit operable to obtain and store licenses for contents according to an operation of the user,
wherein the value information storage unit obtains the value Information when one or more specific licenses are stored in the license storage unit.

28. The content using apparatus according to claim 1,
wherein the value information storage unit obtains the value information depending on an attribute of the user.

29. The content using apparatus according to claim 1,
wherein the value information storage unit rewrites or generates a part or all of the value information.

30. The content using apparatus according to claim 1,
wherein the value information using unit converts one or a predetermined number of the value information into another value information.

31. A distribution server for distributing value information indicating a benefit for a user to a content using apparatus for providing content use to the user under a license, comprising:
a value information generation unit operable to generate value information indicating the benefit for the user and a condition for allowing the user to use the value information depending on the content use; and
a distribution unit operable to distribute the generated value information and the condition to the content using apparatus.

32. A content using method for providing content use to a user under a license that grants the content use, comprising:
a value information storage step of obtaining and storing value information indicating a benefit for the user;
a condition judgment step of judging, depending on the content use, whether a condition for allowing the user to use the value information is satisfied or not; and
a value information using step of allowing the user to use the value information when the condition is satisfied as a result of the judgment.

33. A content using program for providing content use to a user under a license that grants the content use, the program causing a computer to execute:
a value information storage step of obtaining and storing value information indicating a benefit for the user;
a condition judgment step of judging, depending on the content use, whether a condition for allowing the user to use the value information is satisfied or not; and
a value information using step of allowing the user to use the value information when the condition is satisfied as a result of the judgment.
